(19) United States
(12) Patent Application Publication
(10) Pub. No.: US 2006/0014938 A1
(43) Pub. Date: Jan. 19, 2006

(54) Stable aqueous colloidal lanthanide oxides

(76) Inventors: Ernest V. Groman, Brookline, MA (US); Christopher P. Reinhardt, Worcester, MA (US); Dennis E. Vaccaro, Wellesley, MA (US)

Correspondence Address: LAWSON & WEITZEN, LLP, 88 BLACK FALCON AVE, SUITE 345, BOSTON, MA, 02210, US

(21) Appl. No.: 11/099,832

(22) Filed: Apr. 6, 2005

Related U.S. Application Data
(60) Provisional application No. 60/587,807, filed on Jul. 14, 2004.

(51) Int. Cl. C08J 3/02

(52) U.S. Cl. 534/15; 516/105

(57) ABSTRACT

A stable aqueous colloidal lanthanide oxide is provided, which can be sterilized by filtration, gamma irradiation, and autoclaving. The stable colloid is also provided having one or more polymers associated to confer biological properties. Compositions, methods of making the compositions, and methods of using the compositions are provided as agents for enhanced magnetic resonance imaging, enhanced computer tomography, cell labeling and cell-tracking in vivo, neutron capture therapy, and brachytherapy, the agents comprising lanthanide oxides as stable colloidal suspensions in water based solvents.

### RELATED APPLICATION

The present application claims the benefit of U.S. provisional application 60/587,807 filed Jul. 14, 2004 in the U.S. Patent and Trademark Office, and which is incorporated herein by reference in its entirety.

### TECHNICAL FIELD

The field relates to compositions which are stable colloidal suspensions of lanthanide oxides in water based solvents, the particles being polymer associated, the polymer conferring biological and chemical properties to the colloids, and relates also to methods of preparing the compositions for use as magnetic resonance imaging (MRI) contrast agents, computer tomography (CT) contrast agents, cell labeling and cell tracking agents, and having applications in neutron capture therapy and brachytherapy.

### BACKGROUND

Since the invention of magnetic resonance imaging (MRI), CT, neutron capture therapy, brachytherapy, and cell labeling technology, a parallel technology of injectable chemicals, referred to as contrast agents and neutron capture agents has developed. Contrast agents play an important role in the practice of medicine in that they help produce more useful images for diagnostic purposes. In the field of MRI, classes of imaging agents have been developed and adopted in clinical practice, including low molecular weight gadolinium complexes and colloidal iron oxides. Gadolinium-based reagents (T1 agents) have the advantage of being brightening reagents, but have the disadvantage of having a short intravascular half-life. Colloidal iron oxide reagents (T2 agents) have the advantage of having a long intravascular half-life, but have the disadvantage of providing a weak brightening signal. Agents that can provide a long intravascular half-life and can provide a strong T1 signal (a brightening reagent) are highly desirable, combining the qualities of each of these classes of agents.

### SUMMARY

The present invention in one embodiment provides a composition which is a stable aqueous colloid comprising at least one lanthanide oxide. The stable aqueous colloid in some embodiments includes at least two lanthanide oxides such that the lanthanide oxides are formed separately and are subsequently mixed. Further provided herein is a stable aqueous colloid comprising a set of colloidal particles such that each particle contains two or more lanthanide elements as oxides. For each of these embodiments, at least one lanthanide oxide is selected from oxides of the group of lanthanide elements consisting of lanthanum, cerium, praseodymium, neodymium, promethium, samarium, europium, gadolinium, terbium, dysprosium, holmium, erbium, thulium, ytterbium, and lutetium. For example, the lanthanide oxide is gadolinium oxide.

In general, the colloid has a size of between about 1 nm and about 500 nm, in which the size refers to the diameter of the particle. Further, the distribution of colloid particle sizes has a standard deviation value which is less than about 150% of the mean value of the distribution.

In related embodiments, the lanthanide oxide is associated with a polymer, for example the lanthanide oxide is gadolinium oxide. Further, the polymer is selected from the group consisting of polyol, polyether, polyphosphoester, and polyamide. An exemplary polyol is a polysaccharide, for example, the polysaccharide is a dextran, a reduced dextran or a derivatized dextran. An exemplary derivatized dextran is carboxy methyl reduced dextran. In related embodiments the polymer is crosslinked, for example, the polymer is crosslinked with an agent selected from the group consisting of epichlorohydrin, glutaraldehyde, di-N-hydroxysuccinimide suberate, diethylenetriaminepentaacetic acid anhydride, cyanogen bromide, ethylchloroformate, and divinyl sulfone. Further, the polymer in a related embodiment is an amine containing polymer. The polymer in certain embodiments facilitates opsonization, in vivo in a subject. Alternatively, the polymer blocks or inhibits opsonization.

The compositions herein are useful in certain embodiments as imaging agents, and the associated polymers can confer a range of advantageous characteristics in vivo following administering to a subject. The polymer in various embodiments following administration facilitates opsonization; alternatively, the polymer blocks opsonization, and/or the polymer facilitates receptor binding, when the colloid is administered to a subject. Further, the colloid has a plasma half-life in a subject that is greater than about 1 minute, for example, the colloid has a plasma half-life in a subject that is greater than about 10 minutes. Advantageously, the colloids provided herein have minimal toxicity, for example, the colloids provide minimal incidence of anaphylaxis in a subject. The colloid can be administered to a subject at a rate substantially greater than about 1 mL/min, or greater than about 10 mL/min. In general, the subject is a mammal, for example, the subject is human.

The lanthanide oxide of colloids provided in certain embodiments herein have magnetic properties. Further, these colloids are stable at a temperature of at least about 100° C., for example, at a temperature of at least about 121° C. Further, the composition is stable at a temperature of at least about 121° C. for a period of time effective to sterilize the complex wherein the sterilization time is at least about 5 minutes, i.e., is between about 5 minutes and about 600 minutes. Accordingly, an embodiment of the colloid composition is sterile, for example, is sterilized by autoclaving. Alternatively, the composition is sterilized by sterile filtration or by gamma irradiation.

In general, the lanthanide oxide colloid has a core consisting substantially of at least one crystal of lanthanide oxide. The colloid is generally suspended in a buffer having physiological pH and osmolarity. The colloid and buffer may be sterilized by autoclaving.

Another embodiment of the invention provided herein is a method of synthesis of a stable aqueous colloid comprising at least one lanthanide oxide, the method comprising: providing an aqueous acidic solution including at least one lanthanide salt and at least one polymer; and neutralizing the solution by controlled addition of a solution of a base. A related embodiment is a method of synthesis of a stable aqueous colloid comprising a plurality of lanthanide oxides, the method comprising: preparing separately at least two stable aqueous colloidal lanthanide oxides by the methods above; and combining the two oxides. Also provided is a method of synthesis of a stable colloidal aqueous lanthanide oxide that includes, prior to neutralizing the solution, providing an aqueous acidic solution that has at least two lanthanide salts and polymer, and then neutralizing the solution by the controlled addition of a solution of a base.

For any of these methods the lanthanide salt is a halide or an acetate; for example, the halide is a chloride. Any of these methods can further include heating the neutralized solution to a temperature of between about 25° C. and about 121° C. The duration of the heating is in the range of about 0.1 min to about 24 hours, for example, about 1 min to about 10 hours, or about 10 min to about 2 hours, or about 15 min to about 1 hour.

Further provided is a method of synthesis of a stable aqueous colloid comprising a plurality of lanthanide oxides, the method comprising: preparing separately a plurality of stable aqueous colloidal lanthanide oxides, i.e., at least two stable aqueous colloidal lanthanide oxides according to any of the above methods; and combining subsequently the at least two oxides. In related embodiments, the method includes providing a polymer, for example, the polymer is a polysaccharide. A typical polysaccharide used in the methods herein is an arabinogalactan, a dextran, a reduced dextran, or a derivatized dextran. In various embodiments, the derivatized dextran is carboxy methyl reduced dextran. In any of these methods, the aqueous acidic solution includes at least one lanthanide salt selected from the group consisting of lanthanum, cerium, praseodymium, neodymium, promethium, samarium, europium, gadolinium, terbium, dysprosium, holmium, erbium, thulium, ytterbium, and lutetium. The colloid in certain embodiments possesses magnetic properties, and has a core consisting substantially of at least one crystal of lanthanide oxide. The ratio of the amount of polymer to the amount of lanthanide salts is between about 0.1:1 and about 50:1 by weight.

In other embodiments, the method further comprises crosslinking the polymer. For example, the step of crosslinking the polymer is performed with a crosslinking agent selected from the group consisting of epichlorohydrin, glutaraldehyde, di-N-hydroxysuccinimide suberate, diethylenetriaminepentaacetic acid anhydride, cyanogen bromide, ethylchloroformate, and divinyl sulfone. In some embodiments, the method further includes modifying the cross-linked polymer, for example, with a reagent selected form an amine, a carboxyl, a sulfhydryl, a sulfate, and a diene. Thus the method provides the step of aminating the resulting crosslinked polymer.

The method further comprises, prior to a heating step, maintaining the temperature of the aqueous acidic solution between about 0° C. and about 95° C. The base for the neutralizing step is, for example, sodium hydroxide, sodium carbonate, or ammonium hydroxide. The method in various embodiments involves sterilizing the stable colloid, for example, by any of autoclaving, gamma irradiating, and filtering. The sterile colloid, for example the filter-sterilized colloid, can further be lyophilized. The colloid can be lyophilized in the presence of a compatible excipient, such as a dextran or a citrate anion.

The method further comprises contacting a cell with colloid, and the colloid is capable of interacting with a cell receptor and undergoing receptor mediated endocytosis into a specific population of cells. In any of the methods, the polymer is a polysaccharide, for example, a dextran; and the ratio of the amount of dextran to the amount of lanthanide salts is about between about 0.1:1 and about 50:1 by weight, and the resulting colloid comprises a core having at least one crystal of lanthanide oxide.

An embodiment of the invention herein is a use of a composition comprising at least one sterile stable aqueous lanthanide oxide colloid for purposes of research, diagnosis, or therapy. Accordingly in some related embodiments, prior to use the composition is sterilized by autoclaving. Further, the use involves providing the sterile composition in a unit dosage of between about 0.1 mL and about 500 mL.

In a related embodiment, the stable aqueous colloid is provided as a contrast agent for magnetic resonance technology. The contrast agent is provided at a physiological pH and osmolarity, and is terminally sterilized by autoclaving. The use for imaging an organ, tissue or at least one cell of a subject by in vivo magnetic resonance (MR), further involves: administering to the subject an effective amount of the stable sterile aqueous colloid dispersed in a physiologically acceptable carrier; and obtaining an MR image. For example, the lanthanide oxide is gadolinium oxide. Accordingly, the stable aqueous colloid comprising at least one lanthanide oxide is a T1 magnetic resonance contrast agent. Alternatively, the stable aqueous colloid comprising at least one lanthanide oxide is a T2 magnetic resonance contrast agent.

In yet another embodiment, the stable aqueous colloid is provided as a contrast agent for computer assisted tomography. Accordingly, the contrast agent is provided at a physiological pH and osmolarity, and is terminally sterilized by autoclaving. The use further involves: administering to the subject an effective amount of the stable sterile aqueous colloid dispersed in a physiologically acceptable carrier; and obtaining the CT image.

In yet another embodiment, the stable aqueous colloid is provided as an agent for neutron capture therapy. Accordingly, the neutron capture therapy agent is provided at a physiological pH and osmolarity, and is terminally sterilized by autoclaving. The use further involves: administering to the subject, organ, tissue or cell an effective amount of the sterile stable aqueous colloid dispersed in a physiological acceptable carrier, and exposing the subject, organ, tissue or cell to neutrons, wherein the neutrons activate the lanthanide resulting in production of charged particles for treating the subject, organ, tissue or cell. In a related embodiment, the organ, tissue or at least one cell is administered the colloid ex vivo. Alternatively, the organ, tissue or at least one cell is administered the colloid in vivo. The charged particles are alpha particles, or are electrons.

In yet another embodiment, the stable aqueous colloid is provided as a brachytherapy agent. Accordingly, the brachytherapy agent is provided at a physiological pH and osmolarity, and is terminally sterilized by autoclaving. The use further involves exposing the colloid to neutrons to obtain a radioactive colloid. In a related embodiment, the exposure of the colloid to neutrons occurs ex vivo. Alternatively, the exposure of the colloid to neutrons occurs in vivo. The use further involves administering an effective amount of the radioactive colloid to the subject.

In yet another embodiment, the stable aqueous colloid is provided as a cell or virus labeling agent for tracking cells or viruses. The use further involves contacting the cells with the stable aqueous colloid. In a related embodiment, the cells are in a subject. In an example of this embodiment, the stable aqueous colloid further comprises a coating that targets a specific set of cells. Further, the cell tracking agent is provided at a physiological pH and osmolarity and is terminally sterilized by autoclaving.

In yet another embodiment, the stable aqueous colloid is used to assess the success of cellular therapy. In a related embodiment, contacting the cells is performed ex vivo. For example, the cells selected for labeling are eukaryotic cells, for example, human therapeutic stem cells. The human stem cells are “therapeutic,” i.e., are used for organ repair or regeneration, so that tracking of labeled cells is evaluative of the progress of the therapy. Tracking in certain further embodiment further involves imaging the cells by magnetic resonance technology or neutron activation analysis.

These methods can further comprise administering the colloid to a subject and the colloid has a plasma half-life in a subject that is greater than about 1 minute. Any of these methods can further include sterilizing the stable colloid, for example, by autoclaving; by exposing the colloid to gamma irradiation; or by filtering the colloid suspension. The method can further include lyophilizing the resulting-sterilized colloid, for example, the filter-sterilized colloid, and the filter-sterilized colloid can be lyophilized in the presence of a compatible excipient. The excipient can be a dextran or a citrate anion. The method can further include reconstituting the lyophilized colloid with an aqueous composition.

Another embodiment of the invention is a method of providing a stable aqueous colloid for administration to a mammalian subject, the method comprising providing at least one lanthanide oxide polymer complex according to any of the above methods, and sterilizing the complex by autoclaving. The method can further involve providing the resulting autoclaved composition in a unit dosage. For example, the unit dosage is between about 0.1 mL and about 500 mL.

Also featured is a method of providing a stable aqueous colloid comprising at least one lanthanide oxide for use as a contrast agent for magnetic resonance (MR) technology, the method comprising formulating the stable aqueous colloid comprising at least one lanthanide oxide at a physiological pH and osmolarity; and terminally sterilizing the composition by autoclaving. Also featured is a method of imaging an organ or tissue of a human or animal subject by in vivo magnetic resonance (MR), the method comprising: administering to the subject an effective amount of a stable aqueous colloid comprising at least one lanthanide oxide dispersed in a physiologically acceptable carrier, wherein the colloid is sterilized by autoclaving; and obtaining an MR image. Accordingly for either of these methods, an exemplary at least one lanthanide oxide is gadolinium oxide. For either of those methods, the stable aqueous colloid comprising at least one lanthanide oxide is a T1 magnetic resonance contrast agent.

Also featured is a method for providing a stable aqueous colloid comprising at least one lanthanide oxide for use as a contrast agent for computer assisted tomography, the method comprising formulating the stable aqueous colloid comprising at least one lanthanide oxide at a physiological pH and osmolarity; and terminally sterilizing the composition by autoclaving. Also featured is a method for obtaining an in vivo computer assisted tomography image of an organ or tissue of a human or animal subject, the method comprising administering to the subject an effective amount of a stable aqueous colloid comprising at least one lanthanide oxide dispersed in a physiologically acceptable carrier, wherein the colloid is sterilized by autoclaving; and obtaining an image. According to either of these methods, at least one of the lanthanide oxides is gadolinium oxide. Also featured is a method for providing a stable aqueous colloid comprising at least one lanthanide oxide for use as an agent for neutron capture therapy, the method comprising formulating the stable aqueous colloid comprising at least one lanthanide oxide at a physiological pH and osmolarity; and terminally sterilizing the composition by autoclaving.

A featured embodiment herein is a method for treating an organ or tissue of a human or animal subject, the method comprising administering to such subject an effective amount of a stable aqueous colloid comprising at least one lanthanide oxide dispersed in a physiologically acceptable carrier; sterilizing the composition by autoclaving; and exposing the subject organ or tissue to a beam of neutrons, wherein the neutrons activate the lanthanide oxide resulting in production of charged particles, thereby treating the organ or tissue. For example, the charged particles are alpha particles or electrons. The at least one lanthanide oxide is, for example, gadolinium oxide.

Also featured is a method for providing an agent for brachytherapy comprising formulating at least one lanthanide oxide as a stable aqueous colloid. The stable aqueous colloid is formulated at a physiological pH and osmolarity. The method in related embodiments further includes terminally sterilizing the colloid by autoclaving. The method in related embodiments further includes exposing the colloid to a beam of neutrons to obtain a resulting radioactive colloid. The method in related embodiments further includes administering an effective amount of the radioactive colloid to a subject. In any of these related embodiments, the at least one lanthanide oxide can be gadolinium oxide.

Also featured is a method of providing a stable aqueous colloid cell labeling agent, the method comprising: formulating at least one lanthanide oxide for use as a cell labeling agent. Also featured is a method of labeling cells, the method comprising: contacting the cells with a stable aqueous colloid comprising at least one lanthanide oxide, for example, incubating a cell culture with a stable aqueous colloid comprising at least one lanthanide oxide. For any of these methods, at least one lanthanide oxide is selected from the group of elements consisting of lanthanum, cerium, praseodymium, neodymium, promethium, samarium, europium, gadolinium, terbium, dysprosium, holmium, erbium, thulium, ytterbium, and lutetium. These methods can further include, prior to the contacting or incubating, dispersing the colloid in a physiologically acceptable carrier. These methods can further include sterilizing the colloid.

An embodiment of the invention provides a method for treating an organ or tissue of a human or animal subject, including administering to the subject cells containing a stable aqueous colloid comprising at least one lanthanide oxide. Accordingly, the method can further include imaging the cells by magnetic resonance technology.

### BRIEF DESCRIPTION OF THE DRAWINGS

FIG. 1 is a set of photomicrographs showing results from a cell viability test using Pig MSCs. Panel A shows unlabeled cells grown for six days. Panel B shows cells grown identically to cells in Panel A except that the cells were labeled with europium oxide colloid (added to the growth medium) for six days. Panel C shows cells grown as in panel A except that thimerasol was added to the growth medium. Cells showed severe deterioration after 24 hours when the photograph in Panel C was taken.

FIG. 2 is a set of photographs of a T1 weighted image from a series of compounds having the same molar concentrations, as shown on the left and normalized intensity values, as tabulated on the right. The compound in row 1 is Gd-DTPA, in row 2 is gadolinium oxide colloid prepared according to Example 14, and in row 3 is water.

### DETAILED DESCRIPTION OF EMBODIMENTS

In the field of CT contrast agents, only low molecular weight iodine containing molecules have proven useful. However, these low molecular weight agents are cleared by the kidneys, which can be problematic in patients with renal disease. Colloids such as iron oxides are cleared from the circulation via the liver, but do not have a sufficiently strong cross section to absorb X-rays effectively. Therefore, biological properties that are associated with iron-based colloids cannot be exploited for medical applications using CT. Lanthanide oxides are superior to iodine in ability to absorb X-rays. Therefore, a stable colloidal lanthanide oxide capable of being autoclaved while retaining the biological properties of a colloid would provide an improved X-ray attenuation agent together with the biological properties conferred by colloids. Such a reagent would provide new combinations of important properties for CT imaging agents.

In the field of neutron capture therapy, therapeutic agents utilize low molecular weight molecules containing isotopes, such as boron or gadolinium. The compound is directed to the site of interest and then the site is exposed to a field of epithermal neutrons. As a result, a therapeutic isotope, either boron or gadolinium absorbs the neutron and then emits either an alpha or a beta particle. This emission has a high probability of destroying the surrounding cells of interest, such as cancer cells. Using a colloid of gadolinium as the therapeutic matrix, rather than a low molecular weight compound, offer two advantages: first, the colloid will remain in circulation for a longer period of time increasing the probability of meeting the desired receptor site and second, the gadolinium colloid contains a significantly higher concentration of neutron absorbing material compared to a low molecular weight boron or gadolinium compound, thereby increasing the lethality following the absorption of neutrons of the emitted particle.

In the field of brachytherapy, radioactive isotopes are placed within seeds or plated onto a surface and then implanted for a period of time in vivo for therapeutic applications. A stable colloid offers the advantage that, once rendered radioactive, the emitted radiation will have a high focal dose rate as a point source, as compared to a single atom of the element.

In the field of cell labeling, radioactive or fluorescent molecules have generally been used to label and then track cells. Radioactivity has distinct disadvantages, i.e., instability of the radionuclide, and regulatory and health issues. Fluorescent molecules cannot be readily detected in in vivo systems. More recently, a new agent called CLIO (crosslinked iron oxide) has been reported for labeling cells (Kircher, M et al, 2004, Bioconjug Chem 15 (2): 2420248). This agent uses a T2 (darkening) MRI colloidal iron oxide. Lanthanide oxides present four opportunities not available with radioactivity, fluorescent, and MRI contrast agent technologies for the labeling of cells. First, there are multiple lanthanide oxides that can be used as labels for cells. These lanthanides then can be quantified in any tissue by neutron activation, using methods as described in PCT/US02/05004 published Aug. 15, 2002, WO 02/062397 and which is incorporated herein by reference in its entirety. Second, the colloids are not radioactive while in the cell and in the in vivo host and therefore provide a safer labeling material both for the cell, the host, and the investigator. Third, depending on the lanthanide oxide, colloids can also provide the ability to be measured by MRI imaging. Fourth, multiple measuring properties can be combined within a single colloid providing, for instance, detection by MRI (T1 agent, brightening), neutron activation and electron microscopy. Therefore, such a reagent provides new ways to label or mark cells, and to track them in vivo.

Definitions

The term “administration” or the phrase “administering a sample to a subject” includes but is not limited to introduction of the sample by routes that include intracellular, intravenous, intraarterial, intraperitoneal, intramuscular, subcutaneous, intradermal, intraorgan, rectal, pulmonary, occular, ventricular (brain), spinal tap, and sublingual means and by needle, by catheter, by aerosol, by gavage, by lymphography, and by topical routes such as skin patch and transdermal devices.

An “associated polymer” as used herein refers to a polymer that is closely linked with colloidal lanthanide oxides. Associated polymer may coat the colloid, i.e., surround the lanthanide oxide particle. It may be covalently or non-covalently attached to the lanthanide oxide. Associated polymer may be interlaced with lanthanide oxide crystals so as to form a stable colloid. Other terms used herein to indicate colloid associated polymer are polymer colloid complex, and lanthanide oxide complex.

A “carboxy polyol” as used herein refers to polysaccharides in which the terminal reducing sugar has been oxidized to a carboxyl group.

A “carboxy alkylated polyol” as used herein refers to polysaccharides that have been heavily oxidized producing multiple carboxyl groups or have been reacted with alkylating organic acids such as bromoacetic acid and bromohexanoic acid.

A “colloid” as used herein shall include any macromolecule or particle having a size less than about 500 nm in diameter, or less than about 250 nm. The lanthanide oxide polymer-associated colloids herein have optimum physical characteristics and manufacturability. Optimum physical characteristics are evident in the ability of the colloid to withstand heat stress, as measured by subjecting the colloid to a temperature of 121° C. for 30 minutes. Following heat stress, the colloid particles made according to the methods herein remain colloidal, and exhibit no appreciable change in size.

A stable aqueous colloidal lanthanide oxide is also referred to herein as a “nanoparticle.”

The term “crystal” refers to a regular or irregular array of atoms.

The term “derivatizing” and related terms (e.g. derivatives, derivatized, derivatization, etc) as used herein refer to the conventional sense of functionalization at the reactive sites of the composition.

The term “halide” refers to iodide, bromide, chloride.

As used herein and in the accompanying claims, the expression “heat stress” means a method of heating a colloid to about 121° C. or higher for about 30 minutes at neutral pH, or other combinations of time, temperature, and pH that are well known in the art to autoclave (or terminally sterilize) an injectable drug. The time interval of heating sufficient for sterilization may be 10 minutes, 60 minutes, or 120 minutes, depending on the volume of colloid being heated.

The term “label” or “labeling” means introduction of at least one stable lanthanide oxide colloid to a cell in culture (in vitro or ex vivo) or in a subject by general administration or receptor targeting followed by measurement of the amount of the label by at least one of various methods, including but not limited to neutron activation, fluorescence, MRI, or electron microscopy.

The term, “lanthanide” as used herein means any element from the following list, commonly referred to in the periodic table as the lanthanides: lanthanum, cerium, praseodymium, neodymium, promethium, samarium, europium, gadolinium, terbium, dysprosium, holmium, erbium, thulium, ytterbium, lutetium

The term, “magnetic properties” as used herein refers to classification of most substances into one of three groups, depending on these properties. Substances having “paramagnetic” properties are attracted by a strong magnetic field, whereas those repelled are designated, “diamagnetic”. The third and most recognized class, “ferromagnetic”, are unique in their ability to retain their own magnetic field, and therefore are useful as materials for construction of permanent magnets. Unlike ferromagnetic magnetic materials, the magnetic properties of diamagnetic or paramagnetic materials can only be observed and measured when they are placed in an external magnetic field. The external magnetic field becomes more concentrated when passing through a paramagnetic substance and becomes weaker when passing through a diagmatic material.

“Magnetic resonance technology” as used herein includes magnetic resonance imaging (MRI), magnetic resonance spectroscopy (MRS), magnetic resonance angiography (MRA), functional magnetic resonance imaging (fMRI), and cine magnetic resonance imaging (cineMRI).

“MSC” as used herein means mesenchymal stem cells.

The term “neutralizing or neutralized” refers to adjusting the pH of a solution to greater than or equal to 7.

“Opsonization” as used herein means the process that results in materials both molecular and particulate being internalized by cells of the reticular endothelial system.

Examples of “pharmaceutical formulations” or “pharmaceutically acceptable salts” or “pharmaceutically acceptable buffers” for pharmacological and biomedical use include but are not limited to applications of MRI, CT, neutron capture therapy, brachytherapy, cell labeling and tracking, monitoring injection technique including the use of catheters, and the like.

“Polyamides” as used herein includes compounds such as peptides and proteins. “Polyethers” refers to compounds such as polyethylene glycol and derivatives thereof. “Polyols” refers to polysaccharides including arabinogalactan, dextran, hydroxyethyl starch, dextrin, mannan galactan, sulfated dextran and diethylaminodextran and derivatives thereof, including carboxyalkyl dextrans. “Polyphosphoesters” as used herein includes compounds such as nucleic acids, similar synthetic analogs including single, double, and triple stranded DNA, RNA, RNAi, siRNA, and antisense molecules.

“Polymer” as used herein includes the usual definition of polymers including oligopolymers that are polymers consisting of 10 or fewer momomeric units.

“Receptor binding” as used herein means binding of a composition provided herein to a peptide, carbohydrate, polysaccharide, lipid or neucleic acid or to a protein or modified protein or recombinant protein of biological origin, or to a protein complex, the protein comprising a receptor having a feature on its surface capable of specific recognition and binding to the composition. The composition may be a biologically functional “ligand” for that receptor, further capable following binding of activating the receptor or blocking binding of another ligand. Receptor binding is generally specific to a cell line or a cell type, such that binding occurs to that line or type with greater affinity and more rapidly than to other cell lines or cell types.

“Stable colloidal suspension” as used herein refers to a characteristic of the compositions herein, which is ability of the colloid to withstand storage of an extended period of time (months to years) at room temperature and at one g of gravity, without forming a precipitate. A specific example of a stable colloidal suspension is the ability of that colloid to withstand heat stress, as demonstrated by subjecting the colloid to a temperature of 121° C. for 30 minutes. Compositions herein following this exposure remain colloidal, do not aggregate as indicated by inability to precipitate by centrifugation at, for example, 500 g, and do not settle out at one g gravity.

The term “subject” refers to an animal, plant or cell including mammals and humans. The term “cell” refers to a eukaryotic or a prokaryotic cell.

“Water based solvent” as used herein means a liquid phase fluid comprising water (generally distilled or deionized water) at least about 20%, at least about 30%, at least about 40%, at least about 50% of the fluid by volume or by weight is water.

### Embodiments

An embodiment of the invention is a composition consisting of at least one lanthanide oxide which forms a stable colloidal suspension in a water based solvent, the solvent including but not limited to water, pharmaceutical formulations, buffers, blood, lymph and urine.

Another embodiment of the invention is a composition comprising at least one lanthanide oxide, each lanthanide oxide forming together a stable colloidal suspension in a water based solvent including but not limited to water, pharmaceutical formulations, buffers, and any of a variety of biological fluids, including but not limited to blood, lymph and urine.

Another embodiment of the invention is a composition consisting of lanthanide oxide colloidal particles, each colloidal particle containing at least two lanthanide oxides, the colloidal particles forming a stable colloidal suspension in a water based solvent including but not limited to water, pharmaceutical formulations, buffers, blood, lymph and urine.

Another embodiment of the invention is a composition wherein the lanthanide oxide is associated with a polymer. The polymer is chosen from a group including: polyols, including carboxy polyols, and carboxy alkylated polyols; reduced polyols and carboxy alkylated polyols. The term “polyol” as used herein includes polysaccharides and reduced polysaccharides such as dextran, mannan, arabinogalactan; carboxy polyols include (mono)carboxy dextran (U.S. patent application number 20030185757) and polycarboxy dextran; and carboxy alkylated polyols including polysaccharides chemically alkylated with acids such as chloro and bromo acetic acid and bromo hexanoic acid (polycarboxy dextran; U.S. patent application number 20030185757); natural and synthetic structural type polysaccharides such as pectins, polygalacturonic acid glycosaminoglycans, heparinoids, celluloses, and marine polysaccharides dermatans, heparins, heparans, keratans, hyaluronic acid, carrageenans and chitosans, chondroitin; synthetic polyaminoacids such as homo or copolymers of aspartic acid glutamic acid or polylysine; proteins and peptides such as albumin and antibodies; and targeting polymers.

The following are examples of targeting polymers: natural and synthetic oligo- and polysaccharides such as dextran having molecular weights of less than 100,000 Da, mixtures of various dextrans; dextrans of different origin; specially purified dextran (FP=free pyrogen quality); sulfated dextrans, diethylaminodextran, dextrin; fucoidan, arabinogalactan, chondroitin and its sulfates, dermatan, heparin, heparitin, hyaluronic acid, hydroxyethyl starch keratan, polygalacturonic acid, polyglucuronic acid, polymannuronic acid, inulin, polylactose, polylactosamine, polyinosinic acid, polysucrose, amylose, amylopectin, glycogen, glucan, nigeran, pullulan, irisin, asparagosin, sinistrin, tricitin, critesin, graminin, sitosin, lichenin, isolichenan, galactan, galactocaolose, luteose, mannans, mannocarolose, pustulan, laminarin, xanthene, xylan and copolymers, araboxylan, arabinogalactan, araban, laevans (fructosans), teichinic acid, blood group polysaccharides, guaran, carubin, alfalfa, glucomannans, galactoglucomannans, phosphomannans, fucans, pectins, cyclo-dextrins, alginic acid, tragacanth and other gums, chitin, chitosan, agar, furcellaran, carrageen, cellulose, celluronic acid or arabinic acid. Additionally, chemically and/or enzymatically produced derivatives of the listed substances and the low-molecular weight decomposition products of polymolecular compounds are claimed. Optionally, these substances or derivatives can be substituted by any other substance. Polyamino- and pseudopolyamino acids are within the scope of the polymers herein.

Synthetic oligo- and polymers such as polyethylene glycol, polypropylene glycol, polyoxyethylene ether, polyanethol sulfonic acid, polyethylene imine, polymaleimide, polyvinyl alcohol, polyvinyl chloride, polyvinyl acetate, polyvinyl pyrrolidone, polyvinyl sulfate, polyacrylic acid, polymethacrylic acid, polylactide, polylactide glycide, are within the scope of the polymers herein.

Monosugars to oligosugars and related substances such as aldo- and ketotrioses to aldo- and ketoheptoses, ketooctoses and ketononoses, anhydrosugars, monocarboxylic acids and derivatives containing 5 or 6 carbon atoms in their main chain, cyclites, amino and diamino sugars, desoxy sugars, aminodesoxy sugars and amino sugar carboxylic acids, aminocyclites, phosphor-containing derivatives of mono- to oligomers, are within the scope of the polymers herein.

Monomer or oligomercarbohydrates or derivatives having antitumoral properties (higher plants, fungi, lichens and bacteria) such as lipopolysaccharides, or containing one or more of the following structures: β-2,6-fructan, β-1,3-glucan, mannoglucan, mannan, glucomannan, β-1,3/1,6-glucans, β-1,6-glucan, β-1,3/1,4-glucan, arabinoxylan, hemicellulose, β-1,4-xylan, arabinoglucan, arabinogalactan, arabinofucoglucan, α-6/1,3-glucan, α-1,5-arabinan, α-1,6-glucan, β-2,1/2,6-fructan, β-2,1-fructan are within the scope of the polymers herein.

An important prerequisite for the effect of antitumoral polysaccharides is solubility in water, which is characteristic of the β-1,3/1,6-glucans due to branches at position 6. Solubility of polysaccharides that are insoluble in water can be improved by introducing hydrophile and well-hydrated groups. Amino, acetyl, carboxymethyl or sulfate groups may be used, among others such as methyl and ethyl, as substituents; Tensides and surface-active substances such as niotensides, alkyl glucosides, glucamides, alkyl maltosides, mono- and polydisperse polyoxyethylene, quaternary ammonium salts, bile acids, alkyl sulfates, betaines, CHAP derivatives, vitamins, natural and synthetic steroids, fluorescent compounds such as fluorescein and rhodamine can be attached to the polymer associated lanthanide oxide colloids to confer receptor site directability; peptides and proteins particularly antibodies, lectins, and receptors; nucleic acids and similar synthetic analogs including DNA, RNA, RNAi, siRNA, and antisense molecules.

An embodiment of the invention herein provides a method of synthesizing reduced polysaccharide lanthanide oxide complex forming a stable colloidal suspension in a water based solvent including but not limited to water, pharmaceutical formulations, buffers, blood, lymph and urine and having a free lanthanide concentration which is less than 1% of the total lanthanide concentration. In a specific embodiment the reduced polysaccharide lanthanide oxide complex has been autoclaved. In a further embodiment the reduced polysaccharide is a reduced dextran.

In yet a further embodiment, the invention provides a method of synthesizing a reduced derivatized polysaccharide lanthanide oxide complex forming a stable colloidal suspension in a water based solvent including but not limited to water, pharmaceutical formulations, buffers, blood, lymph and urine and having a free lanthanide concentration which is less than 1% of the total lanthanide concentration. In a specific embodiment the reduced derivatized polysaccharide lanthanide oxide complex has been autoclaved. In a further embodiment the reduced polysaccharide is a reduced derivatized dextran.

An embodiment of the invention is a method that includes the steps of mixing a polymer with at least one lanthanide oxide salt in an acidic solution; neutralizing the solution with a base; and recovering the associated lanthanide oxide colloid.

An embodiment of the invention is a method that includes the steps of treating a polysaccharide with a reducing agent such a borohydride salt or with hydrogen in the presence of an appropriate hydrogenation catalyst such Pt or Pd to obtain the reduced polysaccharide, such that the terminal reducing sugar has been reduced to give an open chain polyhydric structure. The reduced polysaccharide may be an arabinogalactan, a starch, a cellulose, an hydroxyethyl starch (HES), an inulin or a dextran. Moreover, the polysaccharide may be further functionalized prior to particle formation. The method further comprises in a related embodiment, mixing the reduced polysaccharide with lanthanide salts in an acidic solution neutralizing the solution with a base, and recovering the resulting polysaccharide-associated lanthanide oxide colloid.

In accordance with a further embodiment of the invention, the synthesis of the colloid is effected by mixing lanthanide salts with a polymer which is followed by the addition of a base. The bases which may be employed are sodium hydroxide, sodium carbonate and more preferably, ammonium hydroxide. The synthesis occurs in an aqueous based solution.

An embodiment of the invention provides a method for the synthesis of a colloid of a lanthanide oxide associated with a water soluble polysaccharide association in a manner that mitigates dissociation of the polymer from the lanthanide oxide when the material is subjected to heat stress.

In a further embodiment of the invention, the polysaccharide derivative is reduced dextran and the lanthanide salts such as halides, acetates, etc. which produce a paramagnetic lanthanide oxide colloid with a water soluble polymer that remains associated with the lanthanide oxide core under heat stress during terminal sterilization.

In another embodiment, a polysaccharide associated colloid may be prepared by adding a polysaccharide to a lanthanide oxide sol (a colloidal dispersion in a liquid), adjusting the pH to 6-8 and recovering the associated lanthanide oxide colloid.

An embodiment of the invention is a method of providing a lanthanide oxide complex, such as gadolinium oxide, for administration to a virus, or to a cell of a prokaryote or eukaryote cell, the method comprising: producing a polymer lanthanide oxide complex, and sterilizing the complex by autoclaving. In general, the polymer is a reduced polymer of glucose. An example of a reduced polymer of glucose is a reduced dextran. The reduced polysaccharide may be produced by reaction of a polysaccharide with a reagent selected from the group consisting of a borohydride salt, or hydrogen in the presence of a hydrogenation catalyst.

Another embodiment of the invention is a composition wherein the lanthanide oxide is associated with a polymer. The polymer further is crosslinked with a chemical chosen from a group including but not limited to epichlorohydrin, glutaraldehyde, di-N-hydroxysuccinimide suberate, diethylenetriaminepentaacetic acid anhydride, cyanogen bromide, ethylchloroformate, and divinyl sulfone.

An embodiment of the invention is a method of providing a lanthanide oxide complex, such as gadolinium oxide, for administration to a multicellular subject including a mammalian subject, the method comprising: producing a polymer lanthanide oxide complex, and sterilizing the complex by autoclaving. In general, the polymer is a reduced polymer of glucose. An example of a reduced polymer of glucose is a reduced dextran. The reduced polysaccharide may be produced through reaction of a polysaccharide with a reagent selected from the group consisting of a borohydride salt or hydrogen in the presence of a hydrogenation catalyst.

Another embodiment of the invention is a method of providing a lanthanide oxide complex, such as gadolinium oxide, for administration to a virus, or to a cell of a prokaryote or eukaryote, the method comprising: producing a derivatized reduced polysaccharide lanthanide oxide complex, and sterilizing the complex by autoclaving. According to this method, producing the complex can include derivatizing a reduced polysaccharide by caboxyalkylation, for example, wherein the carboxyalkylation is a carboxymethylation. Further according to this method, the reduced polysaccharide can be a reduced dextran.

Another embodiment of the invention is a method of providing a lanthanide oxide complex for administration to a multicellular subject including a mammalian subject, the method comprising: producing a derivatized reduced polysaccharide lanthanide oxide complex, and sterilizing the complex by autoclaving. According to this method, producing the complex can include derivatizing a reduced polysaccharide by caboxyalkylation, for example, wherein the carboxyalkylation is a carboxymethylation. The derivatized, reduced polysaccharide can be isolated as the sodium salt.

In yet another embodiment, the invention provides a method of formulating a lanthanide oxide complex associated with a native or reduced polysaccharide. This composition is for pharmacological and biomedical use. The method of formulating such a lanthanide oxide complex comprises: producing a native or reduced polysaccharide lanthanide oxide complex, and sterilizing the complex by autoclaving. Further according to this method, the reduced polysaccharide can be a reduced dextran.

In yet another embodiment, the invention provides a method of formulating a composition which is a lanthanide oxide complex associated with a reduced derivatized polysaccharide. This composition is for pharmacological and biomedical use. The method of formulating such a lanthanide oxide complex comprises: producing a reduced derivatized polysaccharide lanthanide oxide complex, and sterilizing the complex by autoclaving. According to this method, producing the complex can include derivatizing a reduced polysaccharide by carboxyalkylation, for example, wherein the carboxyalkylation is a carboxymethylation. Further according to this method, the reduced polysaccharide can be a reduced dextran. The derivatized, reduced polysaccharide can be isolated as the sodium salt.

Another embodiment of the invention provides a reduced polysaccharide lanthanide oxide complex with magnetic resonance imaging (MRI) T1 relaxation properties to allow contrast agent signal enhancement with T1 sequences. A further advantage of this embodiment is that the reduced polysaccharide lanthanide oxide can be administered multiple times for sequential imaging in a single examination. Yet another aspect of the agent is that it can be used to image multiple organ systems including the vascular system, liver, spleen, bone marrow, and lymph nodes. In a further embodiment, the invention provides a method to evaluate cardiovascular disease.

Another embodiment of the invention provides a reduced derivatized polysaccharide lanthanide oxide complex with MRI T1 relaxation properties to allow contrast agent signal enhancement with T1 sequences. A further aspect of the embodiment is that the reduced derivatized polysaccharide lanthanide oxide can be administered multiple times for sequential imaging in a single examination. Yet another aspect of the agent is that it can be used to image multiple organ systems including the vascular system, liver, spleen, bone marrow, and lymph nodes. In a further embodiment, the invention provides a method to evaluate cardiovascular disease.

Another embodiment of the invention provides a reduced polysaccharide lanthanide oxide complex wherein the lanthanide has a nucleus suitable for neutron capture to allow applications in neutron capture therapy and brachytherapy.

Another embodiment of the invention provides a reduced derivatized polysaccharide lanthanide oxide complex wherein the lanthanide has a nucleus suitable for neutron capture to allow applications in neutron capture therapy and brachytherapy.

Another embodiment of the invention provides a reduced polysaccharide lanthanide oxide complex, which can be used to label cells in vitro and in vivo for cell tracking. A preferred embodiment of the invention provides a reduced polysaccharide lanthanide oxide complex which can be used to label cells in vitro and in vivo for cell tracking and is not toxic to cells in cell culture.

Another embodiment of the invention provides a reduced derivatized polysaccharide lanthanide oxide complex which can be used to label cells in vitro and in vivo for cell tracking. A preferred embodiment of the invention provides a reduced derivatized polysaccharide lanthanide oxide complex which can be used to label cells in vitro and in vivo for cell tracking and is not toxic to cells in cell culture.

In yet a further embodiment, the invention provides a method of administering to a mammalian subject an autoclaved reduced polysaccharide lanthanide oxide complex. Also provided is an improved method of administration comprising: injecting an autoclaved reduced polysaccharide lanthanide oxide complex in a volume of 500 mL or less, for example, 200 mL or less, 100 mL or less, 50 mL or less, 25 mL or less, or 15 mL or less. Another related embodiment comprises injecting the volume as a bolus. In a further related embodiment, the injecting the volume provides improved image quality.

In yet a further embodiment, the invention provides an improved method of administering to a mammalian subject an autoclaved derivatized reduced polysaccharide lanthanide oxide complex. The improved method of administration comprising: injecting an autoclaved reduced derivatized polysaccharide lanthanide oxide complex in a volume of 500 mL or less, for example, 15 mL or less. In another aspect of the embodiment the injected volume is injected as a bolus. In a further aspect of the embodiment, the injected volume provides improved image quality.

In yet a further embodiment, the invention provides a method of administering to a mammalian subject an autoclaved reduced polysaccharide lanthanide oxide complex having a free lanthanide concentration which is less than 1% of the total lanthanide concentration. The improved method of administration comprising: injection of an autoclaved reduced polysaccharide lanthanide oxide complex in a volume of 500 mL or less, for example, 15 mL or less. In another aspect of the embodiment the injected volume is injected as a bolus. In a further aspect of the embodiment, the injected volume provides improved image quality.

In yet a further embodiment, the invention provides an improved method of administering to a mammalian subject an autoclaved derivatized reduced polysaccharide lanthanide oxide complex having a free lanthanide concentration which is less than 1% of the total lanthanide concentration. The improved method of administration comprises: injecting of an autoclaved reduced derivatized polysaccharide lanthanide oxide complex in a volume of 500 mL or less, for example, 15 mL or less. In another aspect of the embodiment the injected volume is injected as a bolus. In a further aspect of the embodiment, the injected volume provides improved image quality.

An embodiment of the invention provides a method of administering to a mammalian subject a reduced polysaccharide lanthanide oxide complex in a manner that the composition provides low toxicity, i.e., is less toxic to the subject than are control compositions lacking polysaccharide, or having polysaccharide that is not reduced.

An embodiment of the invention provides a method of administering to a mammalian subject a reduced derivatized polysaccharide lanthanide oxide complex in a manner that the composition provides low toxicity.

An embodiment of the invention provides a reduced polysaccharide lanthanide oxide complex, wherein the reduced polysaccharide is derivatized, for example, the reduced derivatized polysaccharide is a carboxyalkyl polysaccharide. The carboxyalkyl is selected from the group consisting of carboxymethyl, carboxyethyl and carboxypropyl. Further, the reduced polysaccharide can be a reduced dextran, for example, the reduced dextran can be a reduced carboxymethyl dextran.

An embodiment of the invention provides a reduced polysaccharide lanthanide oxide complex, the complex being stable at a temperature of at least about 100° C. In a specific embodiment, the complex is stable at a temperature of about 121° C. In an even more preferred aspect of the reduced polysaccharide lanthanide oxide complex, the complex is stable at a temperature of at least 121° C. for a time sufficient to sterilize the complex. The sufficient time depends on the volume of the complex subjected to autoclaving, as is known to one of ordinary skill in the art of sterilizing reagents.

An embodiment of the invention provides a reduced derivatized polysaccharide lanthanide oxide complex, such complex being stable at a temperature of at least about 100° C. In a preferred embodiment, such complex is stable at a temperature of about 121° C. In an even more preferred aspect of the reduced derivatized polysaccharide lanthanide oxide complex, such complex is stable at a temperature of at least 121° C. for a time sufficient to sterilize the complex.

An embodiment of the invention provides a reduced polysaccharide lanthanide oxide complex, the complex being sterilized by filtration.

An embodiment of the invention provides a reduced derivatized polysaccharide lanthanide oxide complex, the complex being sterilized by filtration.

An embodiment of the invention provides a reduced polysaccharide lanthanide oxide complex, the complex being sterilized by gamma irradiation.

An embodiment of the invention provides a reduced derivatized polysaccharide lanthanide oxide complex, the complex being sterilized by gamma irradiation.

A specific embodiment of the invention is a method of formulating for pharmacological and biomedical use a reduced polysaccharide lanthanide oxide complex having increased pH stability in comparison to the corresponding native dextran lanthanide oxide, the method comprising: providing dextran; and reacting the dextran with a borohydride salt or hydrogen in the presence of an hydrogenation catalyst, reacting the reduced dextran with lanthanide salts to provide a formulation having a stable pH.

A specific embodiment of the invention is a method of formulating for pharmacological and biomedical use a reduced derivatized polysaccharide lanthanide oxide complex having increased pH stability in comparison to the corresponding native dextran lanthanide oxide, the method comprising: reacting the reduced derivatized dextran with lanthanide salts to provide a formulation having a stable pH.

In another embodiment, the invention provides a method of formulating a reduced derivatized dextran composition for pharmacological and biomedical use wherein the composition has decreased toxicity in comparison to native dextran; comprising: producing a reduced derivatized polysaccharide; and sterilizing the product by autoclaving. According to this method, the reduced polysaccharide is obtained by reacting the native polysaccharide with one of several reducing agents selected from the group consisting of a borohydride salt, or hydrogen in the presence of a hydrogenation catalyst. In a preferred aspect of the embodiment the polysaccharide is dextran. Producing the composition can include derivatizing a reduced polysaccharide by carboxyalkylation, for example, wherein the carboxyalkylation is a carboxymethylation. Further according to this method, the reduced polysaccharide can be a reduced dextran. The derivatized, reduced polysaccharide can be isolated as the sodium salt. In one aspect of the method, producing the derivatized reduced polysaccharide is achieved at a temperature of less than about 90° C., for example, less than about 80° C., 70° C., 60° C., or less than about 50° C. In another aspect of the method, producing the derivatized reduced polysaccharide is achieved at a temperature of less than about 40° C.

Another embodiment of the invention is modifying the surface of the colloidal lanthanide oxide complex to impart specific biological properties. For example, the complex can be modified to direct the material to a specific receptor site in vivo. Yet another embodiment of the invention is providing the lanthanide oxide complex to label cells in vitro, i.e., in cell culture or isolated from other cells, and then implanting the cells in a subject, for example, in a mammalian subject and tracking the labeled cells in vivo via MRI. Another embodiment of the invention is contacting a subject with the lanthanide oxide complex as a therapeutic reagent for neutron-capture therapy or brachytherapy. Yet another embodiment of the invention is contacting a subject with the lanthanide oxide complex which is used as a radio-opaque dye or contrast agent for CT.

The colloids that are an embodiment of the invention are used as contrast agents for magnetic resonance imaging (MRI) or in other applications such as cell labeling, neutron capture therapy, brachytherapy, and targeted drug delivery. These colloids are particularly suited to parenteral administration, because the final sterilization typically is autoclaving, a preferred method since it eliminates viability of all cellular life forms including bacterial spores, and viruses. The embodiments of the present invention, comprising the colloid compositions, are useful as MRI contrast agents, and for cell labeling and cell tracking and neutron capture therapy, brachytherapy, and targeted drug delivery in that similar types of materials have never been made. The improvements provided in these agents over prior art are found in the following advantages demonstrated in the examples herein: that the agents which are embodiments of the present invention (1) are stable colloids, (2) remain stable colloids following heat treatment; (3) are sterilizable by autoclaving, and are thus optimized for long-term storage at ambient temperatures; (4) do not require the addition of excipients for maintenance of stability during the sterilization or storage processes; (4) are non-toxic to mammals at higher doses; (5) an effective dose of the agents used for imaging is a small amount of material; (6) combine T1 imaging properties with functional characteristics of colloids, (7) are both MRI and CT contrast agents simultaneously, and (8) have pharmacokinetics following administration, such that iterated successive doses administered after a brief interval after administration of the first dose can be used to obtain additional images during a single clinical visit and use of the imaging apparatus. In the case of dextran and derivatives thereof, the formulations prepared by this method are less immuno-reactive in mammalian subjects. The dextran- and dextran derivative-associated lanthanide oxide particles yield enhanced imaging of the heart, lungs, kidneys, and other organs and systems (such as the cardiovascular system) in mammals such as rat, pig, and human.

Colloids have found applications in many areas, from the preparation of paints to biomedical and pharmaceutical industries. Aqueous based colloids offer special advantages because they avoid the use of organic solvents which add to health risks, are dangerous to the environment, and require special disposal. Stable colloidal suspensions offer unique advantages over unstable colloidal preparations because they can be stored for long times without mixing, and particle size does not change over the course of a period of time useful for standard applications.

In some situations it can be desirable to have the lanthanide oxide associated with a polymer. Such associations can confer useful biological properties on the colloid. For example, associating colloids with dextran usually confers long blood life times, whereas associating with other polysaccharides such as arabinogalactan can confer receptor directed binding, i.e., binding to cellular receptors. The invention in various embodiments provides several examples of different polymers associated with a lanthanide oxide core. Further, various embodiments of the invention provide for the first time compositions that are stable colloidal lanthanide oxides, and provide the first examples of stable colloidal lanthanide oxides that are associated with polymers.

In some situations it may be desirable to have the lanthanide oxide associated with any of a variety of haptens and receptors. Often these molecules are most easily associated with the colloid through binding to the polymer. Such haptens and receptors confer additional and very specific biological properties not conferred by the polymer. The binding of such molecules to a colloid is often referred to as decoration or decorating the colloid. For example, associating colloids with folate confers binding by specific cancer cells. Associating colloids with biotin allows binding of the colloid by avidin and streptavidin. Examples of receptor-type molecules include avidin, streptavidin, antigens and antibodies, and carbohydrates and lectins, and other well-known ligand-receptor pairs including synthetic ligands. The invention provides several examples of different “haptens” or ligands for receptors, the haptens or ligands being associated with, i.e., bound to, the lanthanide oxide core. The invention is the first example of stable colloidal lanthanide oxides that are associated with haptens and receptors.

For certain applications it is desirable to have the lanthanide oxide associated with any of at least one fluorescent molecule. This for instance in the case of gadolinium oxide would allow the detection of the colloid by MRI and fluorescence. Often these molecules are most easily associated with the colloid. The invention presents several examples of different fluorescent molecules that are associated with the lanthanide oxide core. The invention is the first example of stable colloidal lanthanide oxides that can be associated with fluorescent molecules.

In yet another situation it is desirable to combine biological directability with a hapten or receptor and a fluorescent molecule. This can also be accomplished with stable colloidal lanthanide oxides.

Further treatment of an associated lanthanide oxide with crosslinking chemicals such as epichlorohydrin prior to autoclaving, is used in certain embodiments herein to enhance the stability of the polymer to heat stress including autoclaving and other treatments such as resistance to aggregation in organic solvents. Crosslinking of polymers may allow control of the charge of the colloidal surface as well as facilitate the attachment of ligands to the colloid. Among the list of crosslinking chemicals are epichlorohydrin, glutaraldehyde, di-N-hydroxysuccinimide suberate, diethylenetriaminepentaacetic acid anhydride, cyanogen bromide, ethylchloroformate, and divinyl sulfone. The colloid-associated polymer provided herein can be crosslinked, which further provides for covalent attachment of ligands to the colloid.

Variation in such factors as polysaccharide derivative concentration, base concentration and/or lanthanide concentration can produce colloids having different relaxation values and sizes. Particle size of the product can be controlled by changing the lanthanide/polysaccharide ratios, as desired to obtain a particular resulting particle size.

The process may be adjusted to yield colloids with different biological properties by changing the type of polysaccharide, and further derivatizing the particle after synthesis.

Colloidal Suspensions Comprising at Least Two Unique Preparations of Lanthanide Oxides

For certain applications it is desirable to combine separate preparations of stable aqueous colloidal suspensions. An example of such an application is to combine each of a plurality of preparations having a unique surface characteristic, thereby providing a method for the user to direct each of the colloids to a different particular cell type in the subject following administration of the combination, or to different cell types in a mixed cell culture or tissue culture.

Colloidal Suspensions Containing a Single Colloidal Particle Type Having a Plurality of Lanthanide Elements in each Colloidal Particle

In other circumstances it is desirable to combine two lanthanide elements in a single colloidal particle to form a stable aqueous colloidal suspension. The presence of two elements can allow the user to obtain multiple measurements from the single particle. For instance, a colloidal particle having a composition of 95% gadolinium, 2.5% europium and 2.5% lutetium would allow measurement of the particle following administration to a subject, by each of the techniques of MRI (gadolinium T1 contrast agent), electron microscopy (gadolinium, europium, and lutetium, and neutron activation (lutetium and europium).

Sterilization

Terminal sterilization (autoclaving) is a preferred method of sterilizing compositions intended for injection. Gadolinium chelates which consist of low molecular weight molecules are usually stable to autoclaving. Colloids however are generally unstable to heat stress. The examples herein demonstrate that the compositions herein comprising a colloidal lanthanide oxide can be autoclaved and are stable.

Additional stability of colloids to heat stress can be conferred by the addition of excipients such as citrate, mannitol and similar materials. Addition of excipients increases the expense of manufacture and may also confer undesirable traits to colloids particularly related to safety. The colloids herein do not require such excipients in order to remain stable during autoclaving. Addition of excipients such as mannitol to confer other properties to the bulk solution, such as increased osmolarity or buffering capacity (through addition of phosphate or citrate ions) does not affect the colloidal stability of lanthanides oxides of the present invention.

Under some circumstances of exposure to the heat of the autoclaving process, the polymer coating in a colloid composition can become dissociated from the metal oxide core. The functional consequences of polymer dissociation from the metal core are physical changes in the material such as clumping, biodistribution changes and changes in toxicity profile (increased adverse events). For example a substantial clumping is seen with gadolinium oxides associated with albumin when heated to even moderate temperatures such as 80° C. The colloids reported in this invention are unaffected by autoclaving.

Alternate means of sterilization of the stable colloidal suspensions of lanthanide oxides may be achieved using filtration and gamma irradiation. The materials described in this invention may be sterilized without the use of heat stress. These methods include the use of filter sterilization or exposure to gamma irradiation.

Lyophilization

Lyophilization offers a means of producing a bacteriostatic environment while avoiding the use of preservatives. Lyophilized powders with moisture contents below about 2% are considered bacteriostatic. Thus, by lyophilizing the filter sterilized colloid, the negative consequences of potential microbial growth during storage are eliminated.

However, lyophilization of particles and colloids is often accompanied by aggregation between the particles or colloids, which can be observed as an increase in particle or colloid size. For example, in the production of silanized magnetic particles, a dehydration step is used to bond the silane to the iron oxide surface. This is accomplished by adding a slurry of particles to glycerol and heating to drive off water. Air drying was avoided because of the tendency of particles to aggregate (see U.S. Pat. Nos. 4,554,088 and 4,827,945). Particle aggregation during the lyophilization process can be reduced or eliminated by adding agents that are stabilizing and/or bulking agents, such as sodium citrate, dextran T-10 or dextran T-1.

Lyophilization of filter sterilized paramagnetic lanthanide oxide colloids includes a freezing step, a primary drying step and a secondary drying step, which are known to one of ordinary skill in the art of pharmaceutical sterilization to be standard steps of pharmaceutical lyophilization (see Williams, N. A. and Polli, G. P., J. Parenteral Science and Technology, 38:48-59; 1984.)

An example of a procedure for a lyophilization cycle is as follows. For the freezing step, 10 mL of colloid is placed in a glass bottle, which is then placed in a freeze-drying apparatus, with a shelf temperature set for between −40° C. and −50° C. After 8 hours, the colloid reaches the shelf temperature, i.e. is frozen. For the primary drying step, the vacuum is adjusted to a maximal setting, and the shelf temperature allowed to rise to 0° C. for 48 hours. The vacuum falls during primary drying, having an ending value of less than about 100 microns. For the secondary drying step, the vacuum is maintained and the shelf temperature is increased to +20° C. for 24 hours.

Methods and Compositions for Minimization of Toxicity

Toxicity of a polymer coated lanthanide oxide colloid may arise from at least two sources: (1) the polymer interacting with various immune and inflammatory systems in the host; and (2) the interaction of free gadolinium (not complexed with a polymer) with various organ systems. Specific adverse reactions have been seen with dextran and have been studied in rat models, e.g., an anaphylactic shock type of reaction to dextran can be exhibited by rats and by a small fraction of the human population (Squire, J. R. et al., “Dextran, Its Properties and Use in Medicine,” Charles C. Thomas, Springfield, Ill., 1955). The reaction resembles anaphylactic shock but does not require prior sensitization, and is characterized in rats by the rapid development of prostration, diffuse peripheral vasodilation, and edema of paws, snout and tongue (Voorhees, A. B. et al., Proc. Soc. Exp. Biol. Med. 1951, 76:254). When accompanied by barbiturate anesthesia, it produces marked hypotension and cyanosis (Hanna, C. H. et al., Am. J. Physiol. 1957, 191:615). Another potential source of adverse reactions for lanthanide oxides may occur through interaction of free gadolinium (not complexed with a polymer) with various organ systems, particularly the liver, spleen and capillaries. The most common lesions caused by gadolinium chloride injection in mice were: mineral emboli in capillaries, accumulation of mineral in the mononuclear phagocytic system, hepatocellular necrosis, and lymphoid depletion, necrosis and mineralisation in the spleen. Such observations are similar to those in found rats given gadolinium chloride, therefore toxicity issues should be addressed for any potential compound for use in a subject, and specifically assessed in the course of evaluating the toxicological profile of gadolinium containing compounds being developed for nuclear magnetic resonance imaging (Spencer, A. et al. 1998). “Gadolinium chloride toxicity in the mouse.” (Hum Exp Toxicol 17(11): 633-7).

These potential sources of toxicity are minimized herein through the use of reduced and derivatized dextrans. Further, as lanthanide oxides are sparingly soluble at pH 6 and above, these sources of toxicity are substantially reduced or eliminated for the compositions provided herein.

Applications and Uses of Compositions and Methods

MRI

Table 1 summarizes characteristics of gadolinium DTPA (a previously described MRI contrast agent) and of compositions that are gadolinium oxide complexed with reduced dextran as provided herein, comparing characteristics of these to an ideal vascular contrast agent. The comparison shows that the compositions provided herein have characteristics of an ideal contrast agent for MRI of the vascular system.

TABLE 1
Comparison of properties of an ideal vascular MRI contrast agents with
gadolinium DTPA and colloidal gadolinium oxide
complexed with reduced dextran

| | | Stable | |
|---|---|---|---|
| | Gadolinium | gadolinium | Ideal vascular |
| Property | DTPA | oxide | contrast agent |
| Low production costs | Yes | Yes | Yes |
| Efficient synthesis | Yes | Yes | Yes |
| Autoclavable without | Yes | Yes | Yes |
| excipients | | | |
| Non toxic at vast excess | Yes | Yes | Yes |
| T1 agent | Yes | Yes | Yes |
| Imaging vascular | Yes | Yes | Yes |
| compartment at | | | |
| early phase (as a bolus | | | |
| administration) | | | |
| Imaging vascular | No | Yes | Yes |
| compartment at | | | |
| late stage equilibrium | | | |
| Multiple administration | No | Yes | Yes |
| in single | | | |
| examination | | | |
| Image of multiple | Sometimes | Yes | Yes |
| targets organs | | | |
| Low injection volume | Yes | Yes | Yes |

Magnetic resonance imaging agents act by affecting the normal relaxation times, principally on the protons of water. There are two types of relaxation, spin-spin or T1 relaxation, and spin-lattice or T2 relaxation. T1 relaxation generally results in a brightening of the image caused by an increase in signal. Generally, T1 agents have been of low molecular weight, while T2 agents have been colloids. It is generally believed that a T1 agent provides a superior image to a T2 agent. Prior to the embodiments of the invention herein, T1 processes have been considered useful in imaging of the vascular system and most useful for detailing anatomy. T2 relaxation generally results in a darkening of the image caused by a decrease in signal. T2 processes are generally believed to be most useful in imaging of organs such as the liver, spleen, or lymph nodes that contain lesions such as tumors and are therefore thought of as functional agents.

In general, contrast agents have both T1 and T2 properties; however, either T1 or T2 relaxation can characterize the dominant relaxation property of a particular contrast agent. Low molecular weight gadolinium based contrast agents are T1 agents, and have primary application in the imaging of vascular related medical problems such as stroke and aneurysms, and conditions affecting the brain. Iron oxide based colloidal contrast agents are T2 agents, and have primary application in imaging tumors of the liver and lymph nodes (prostate and breast cancer).

An agent possessing both T1 and particulate colloidal properties would be desirable, to provide superior images to T2 agents, and to be used in applications where a colloidal agent offers superior performance. Using such an agent would (i) provide a single drug for all applications, and simplify the inventory of the pharmacy, (ii) simplify imaging in the MRI suite, (iii) improve image reading since all images would be done using a brightening agent, and (iv) improve patient care by permitting simultaneous examination of multiple medical problems in a single patient during a single examination, rather than requiring use of either a low molecular T1 or a colloidal T2 contrast agent.

Information regarding anatomical features within the vascular system can be obtained using contrast agents in a number of ways. When the contrast agent is first administered as a bolus, it initially passes through the vascular tree as a relatively coherent mass. Coordinating the time of imaging of the desired anatomical feature to the time when the bolus passes through that feature can provide useful information, a technique of contrast agent use that is called first pass imaging. At a later time, the bolus has been diluted by mixing, and attains an equilibrium concentration in the vascular system. Under certain circumstances, this equilibrium or steady state can offer useful information. Imaging can be performed at an early phase, within minutes after injection of the contrast agent (“first pass”), and continuing up to a later phase, that commences from about ten minutes after injection of the contrast agent (“equilibrium phase”). Low molecular weight gadolinium agents are suited only for first pass imaging due to their ready diffusion from the vascular system into the interstitial spaces of the tissues. Previously described colloidal iron oxides are useful for the equilibrium due to their requirement for dilute administration over a prolonged time period. Colloidal lanthanide oxides do not leak into the interstitial space but can remain in the vascular system for hours. An agent offering the opportunity to perform both first pass imaging and equilibrium imaging would be desirable.

During administration in a medical setting of a contrast agent for “first pass” imaging, the timing of imaging and passage of the “first pass” of the contrast agent may not coincide. If a useful image was not obtained, it becomes desirable to administer a second dose of contrast agent to obtain another “first pass” image. On other occasions radiologists may examine several volumes within the patient, a procedure that requires a multiple dosing regimen of contrast agent in order to obtain “first pass” images at each of multiple sites of interest. With low molecular weight gadolinium contrast agents, this multiple administration “first pass” application is not possible because the gadolinium leaks out of the vascular space producing a fuzzy background around blood vessels of interest. Current iron oxide colloidal based contrast agents are not suitable as they are administered not as a bolus, but as a dilute solution over a long time, a protocol that excludes possible “first pass” applications.

Diagnosis of tumor progression in cancer patients is important for characterizing the stage of the disease, and for assessing treatment. To minimize cost and discomfort to the patient, it is desirable in an MRI examination to administer a single dose of contrast agent that would enable assessment of multiple organ systems that might be affected by the disease. For instance, in primary breast cancer, it is desirable to assess tumor status in the breast and at multiple metastatic sites including the liver, spleen, bone marrow, and lymph nodes. Administration of low molecular weight gadolinium based contrast agents can not satisfy this requirement due to short half life in the body, leakage into the vascular system, and inability to accumulate or be concentrated within organs of interest. Iron oxide colloid based contrast agents such as Combidex® can serve in this multiple capacity while Feridex I.V®, another iron oxide colloid contrast agent, is limited to imaging the liver and the spleen. Colloidal lanthanide oxide contrast agents herein provide a contrast agent having the superior properties of gadolinium based contrast agents (image production enhancing anatomy) and the multiple capacities of colloidal iron oxides (colloidal properties elucidating functionalibiological properties).

Administration of a contrast agent in a small volume (less then 5 ml) is desirable, as small volume administration improves the resolution obtained from first pass imaging, and minimizes injection time and discomfort to the patient. Low molecular weight gadolinium based contrast agents are administered in volumes of about 30 mL due to constraints caused by the solubility and potency of these agents. Currently, iron oxide based contrast agents are administered as a dilute solution in a large volume (50-100 ml) over an extended period of time (30 minutes). These constraints arise from safety issues associated with the rapid and concentrated administration of iron oxide based agents. Bolus injection is desirable in that it allows first pass imaging and shortens contact time between the patient and health care provider. Further bolus injection allows the practitioner to administer the contrast agent while the subject is in the MRI apparatus during the examination, thereby optimizing efficient use of instrument imaging time. Gadolinium-based agents provided herein can be administered as a bolus.

Computed Tomography

Although iodine-based contrast agents are widely used for computed tomography (CT) imaging, gadolinium-containing contrast agents have been used in place of iodinated contrast agents for certain applications in conventional angiography and CT. However, use of gadolinium-containing contrast agents is not widespread, partly due to the lesser attenuation exhibited by gadolinium chelates because of the presence of one gadolinium atom per molecule compared to three iodine atoms per molecule of standard CT reagents.

Use of colloidal gadolinium would overcome this drawback. Gadolinium's higher atomic weight (atomic weight=157) and higher k-edge (k-edge=52 keV) makes it comparably radiopaque and a better match to the energy spectrum produced during scanning than iodinated contrast agent (atomic weight=127, k-edge=33 keV), wherein the peak in intensity of the x-ray spectrum occurs at about 50 keV. The x-ray attenuation exhibited by colloidal gadolinium is linear, concentration dependent, and is not influenced by the colloidal matrix, i.e. associations of polymer with the gadolinium. On average, colloidal gadolinium provides up to 100 times the attenuation of equimolar concentration of iodinated CT reagents. Methods of manufacture of a stable colloidal gadolinium-based CT contrast agent, that is free of nephrotoxicity associated with iodine-based reagents, are provided herein. Moreover, the same reagent can be used for both CT and MRI applications.

Cell Labeling and Cell Tracking

Clinical researchers have an increasing understanding of disease mechanisms with new disease-linked genes being reported frequently. With current genomic and proteomic knowledge and technology, it is expected that researchers will continue to fill in the gaps about disease mechanisms. While the technology for discovery of the root causes of diseases is moving forward quickly it appears that the technology for treating disease must move just as rapidly. The need for new therapeutic technologies is illustrated by the fact that many hundreds of diseases are understood well enough to know what therapeutic correction should be made, but no treatment currently exists. An approach with potential to treat many previously untreatable diseases involves utilizing cellular transplants. Such therapeutic cells can be taken either from the patient or from ex vivo sources. For example, several clinical trials are in progress to treat infarct damage in myocardium by transplanting the patient's own skeletal muscle or stem cells. In order to understand the efficacy of cellular therapies, methods to track and quantify the therapeutic cells after administration are needed. The stable lanthanide colloid provided herein can be used to label and track cells in vivo.

Traditional methods to track cells in vivo employ radioactive, fluorescence and genetic compositions and methods. Radioactivity suffers from the well known issues including the generation of radioactive waste and a limitation in the numbers of labels available. Furthermore, the researcher may need to manufacture the labeled probe, and the radioactive tracer per se may have deleterious effects on the cell. A primary fluorescent label is green fluorescent protein (GFP), which while an excellent label, is limited to a single fluorescent signal and requires incorporation of the label gene into the cellular DNA, not an easy process. Further, the health of the target cell may be compromised by the required manipulation of the cell genome, and such manipulation is not suitable for medical applications in human subjects. Tracking cells by measuring genetic differences is difficult, not suitable to many experimental protocols, and not quantitative. Finally, no technology is optimal for both easy quantitative and histological measurement for tracking administered cells. Thus, researchers find themselves in the difficult position of having technologies that “work” but not well enough in a flexible manner to yield the quality of results needed to optimize cell transplantation therapies.

The present invention provides a stable lanthanide colloid reagent that can be manufactured for cell-based applications. Examples herein demonstrate that a cell takes up the reagent and that the reagent is nontoxic. The labeled cells can be tracked by MRI technology, via T1 imaging of gadolinium, and later quantified via neutron activation analysis in collected tissues of interest. The neutron activation measurement can be made using gadolinium directly or by using a secondary isotope within the colloidal matrix having an improved neutron activation signature, such as samarium.

Neutron Capture Therapy

Neutron capture therapy (NCT) is a binary radiotherapy method, which utilizes epithermal neutrons in conjunction with a nonradioactive isotope-labeled reagent, to treat patients with certain malignancies. The isotope could be boron or a lanthanide, such as gadolinium. NCT can be described as neutron activated chemotherapy. Without the neutrons, the stable isotope labeled compound is a nontoxic reagent, having temporal characteristics with respect to concentration within various tissues. After a predetermined period of time, the labeled reagent is preferentially located in tumor cells, and its concentration in healthy tissue is significantly low. During that specific time window, the tumor is irradiated with epithermal neutrons, the neutron is thermalized within the tissue mass and then the neutron interacts with the nonradioactive isotope of the reagent. The activated isotope produces highly toxic alpha and/or electron particles within the tumor cell. Exposure of tumor cells to these radioactive particles kills the cells.

The requirements for NCT to be successful include having a large concentration of the therapeutic isotope in the cells-of-interest and having a sufficient amount of thermal neutrons within the tumor mass. Compositions and methods herein provide for introducing a stable lanthanide oxide colloid, and the surface of the colloid can be modified to enhance its uptake by tumor cells. The high concentration of isotope within the colloid provides greater therapeutic potential than is possible with the use of a low molecular weight reagent. Of the lanthanides listed above, gadolinium, samarium, dysprosium, and lutetium are highly preferred for NCT.

Brachytherapy

Brachytherapy is a method wherein radioactive seeds or sources are placed in or near tissues-of-interest, such as tumor or an artery's surface, yielding a high radiation dose to the area while reducing the radiation exposure in the surrounding healthy tissue. The present invention provides a method for manufacture of stable lanthanide colloids that can be plated onto a surface, such as a tip of a catheter. The colloids can be rendered radioactive at any point in time (before or after plating) via exposure to a high field of thermal neutrons. The advantage of the colloid material over standard isotopic labeling is that the colloid places a high concentration of metal in a small location, thereby significantly increasing the dose rate at any given point and sparing non-target surrounding tissues.

Gadolinium compounds are known to those of skill in the art of imaging agents. Roberts et al. (J Appl Phys 2000 87, 6208-6210) describe a process for making gadolinium oxide liposomes. The nanoparticles have an average diameter of 20 nm and can be suspended in aqueous solutions. The suspension is collected magnetically, however it is not stable. Oyewumi et al (Bioconjugate Chemistry (2003) 14, 404-411) describes a thiamine coated gadolinium nanoparticle. As this material does not contain gadolinium oxide, it is therefore not a colloidal lanthanide oxide. Further, these nanoparticles are not stable in aqueous solution, and they cannot be sterilized by filtration, gamma irradiation, or autoclaving.

Matijevis, U.S. Pat. No. 5,015,452, describes an improved process for the synthesis of uniform colloidal particles of rare earth oxides. These methods yield large colloidal rare earth oxides in the range of a diameter of about 150 nm or greater. Spherical colloidal particles of gadolinium hydroxycarbonate are generated having an initial particle of 200 nm, however over an hour time period the particles aggregate to form larger sized particles in the range of 600 nm. Therefore, the methods in Matijevis et al. generate unstable colloids, i.e., colloids that are not stable as defined herein, and which further are likely to be toxic in vivo.

Maruno et al., U.S. Pat. No. 5,204,457, describes a carboxymethyl-dextran coated magnetic metal oxide particle (iron oxide) with improved stability up to 80° C. for an extended period but does not terminally sterilize by autoclaving. Hasegawa et al. (Japan J. Appl. Phys., Part 1, 37(3A):1029-1032, 1998) describes carboxymethyl dextran coated iron particles with thermal stability at 80° C.

Akaike et al., U.S. Pat. No. 6,372,194 B 1 describes a contrast medium containing a copolymer of a diamine and DTPA complexed with gadolinium. The contrast agent is not an oxide of a lanthanide but merely a conventional chelate of gadolinium. Ranney, U.S. Pat. No. 5,336,762, describes a procedure for making DTPA conjugates of dextran followed by complexation with gadolinium. By suitable manipulation these complexes can be converted to microspheres. The contrast agent is not an oxide of a lanthanide but merely a conventional chelate of gadolinium. Spielvogel, U.S. Pat. No. 5,286,853, describes a procedure for making a macrocyclic compound containing boron and gadolinium to permit MR imaging and/or neutron capture therapy. These compounds are low molecular chelates. The contrast agent is a chelate of gadolinium. Annan et al., U.S. Pat. No. 6,270,784 B1, describe an image enhancing agent having a polymeric core including an image-enhancing compound chemically bound thereto and polymeric shell surrounding the core and compound. Gadolinium is introduced as a salt and is ionically bound at the core. The contrast agent is an ionically bound gadolinium.

Bonnemain et al., U.S. Pat. No. 4,877,600, describes a complex of gadolinium and DOTA, a commercial chelate, formulated as a lysine salt. This compound is a low molecular chelate.

McDonald et al., U.S. patent application 2003/0003054, describes a gadolinium containing particle wherein the gadolinium is imbedded in a protein matrix. Protein coatings can be immunogenic and are not stable to autoclaving. The synthesis is multiphasic and complex. The final product is heterogeneous chemically and by size, and averages about 1 micron (μm) in size. Havron et al., (J Computer Assisted Tomagraphy (1980) 4, 642-648) describes a method for making micron sized lanthanide oxide particulates. These materials flocculate in plasma, are heterogeneous chemically and by size, and average about 1 μm in size.

The various embodiments of the invention having now been fully described, the description is followed by the examples and claims below, which are intended to be exemplary only and are not to be construed as further limiting. The contents of all patents and scientific publications cited are hereby incorporated herein by reference.

### EXAMPLES

General Procedures for the Synthesis of Reduced Polysaccharides

Reduced polysaccharides were prepared by treatment with excess sodium borohydride and generally purified using five cycles of ultrafiltration. Distilled water is used throughout the examples. In all cases, the products showed less than 5% residual aldehyde content. Residual aldehyde concentration was determined using a modified tetrazolium blue assay (Jue, C. K. et al., J. Biochem. Biophys. Methods, 1985, 11:109-15). Dextran concentration was determined by a phenol/sulfuric acid assay (Kitchen, R., Proc. Sugar Process. Res. Conf., 1983, 232-47).

### Example 1

### Reduced Dextran T1

Dextran T1 (10 g) was dissolved in 100 mL water at 25° C., 1.0 g of sodium borohydride was added, and the mixture was stirred for 12 h. The pH was brought to 5.0 using 6 M HCl, and 200 mL ethanol (anhydrous) was added. The precipitate was collected by centrifugation. The ethanol/water layer was decanted, and the residue was dissolved in 100 mL water. Addition of 200 mL of absolute ethanol was used to cause a second precipitation, and the ethanouwater was again decanted. The precipitated product was dissolved in water, and was lyophilized to produce a white solid, with a 60% yield.

### Example 2

### Reduced Dextran T5

Dextran T5 (4 g) was dissolved in 25 mL water at 25° C., 83 mg of sodium borohydride was added, and the mixture was stirred for 12 h. The pH was brought to 5.0 using 6 M HCl. The mixture was ultrafiltered against a 1 kDa molecular molecular weight cut off (MWCO) membrane filter. The product was lyophilized to produce a white solid, and a 70% yield was obtained.

### Example 3

### Reduced Dextran T10

Dextran T10 (5,003 g) was dissolved in 26,011 g water. Sodium borohydride was added (52.5 g) and the mixture was stirred for 24 hours. The pH was adjusted to 7.1 using 6 N HCl. The product was purified by repeated ultrafiltration against a 3 kDa MWCO ultrafiltration membrane and was lyophilized, to produce a white solid.

### Example 4

### Reduced Pullulan

Pullulan (90 mg) was dissolved in 0.8 mL water at 25° C., and 1 mg of sodium borohydride was added. The mixture was stirred for 12 h, and purified as in Example 3.

### Example 5

### Carboxymethyl Reduced Dextran CMRD T10

Sodium borohydride (0.4 g) and 0.5 g of 50% sodium hydroxide were added to a solution of 25 g dextran in 50 g water. The mixture was stirred 4 hours at room temperature, 20.0 g 50% of sodium hydroxide and 6.95 g of bromoacetic acid were added and temperature was kept below 25° C. using an ice bath while the mixture was stirred for 16 hours at room temperature.

To purify the product, the pH of the mixture was adjusted to pH 6.2 using 6 M HCl, and 120 mL ethanol was added. A precipitate formed and was allowed to settle, and the supernatant was removed by decanting: The residue was dissolved in 60 mL water, and 200 mg sodium chloride was added, followed by 30 mL ethanol, and the carboxymethyl reduced dextran was allowed to settle out. The procedures of addition of water and sodium chloride followed by dissolution of the precipitate and ethanol precipitation, were repeated an additional two times. The residue was dissolved in 60 mL water, and 1 liter of ethanol was added. The carboxymethyl reduced dextran was again allowed to settle out, and the solid was collected on a medium frit glass filter. The white solid was dried 24 hours at 50° C. The yield was 23.9 g of product having 1262 micromoles carboxyl per gram as measured by titration.

General Procedure for the Preparation of Stable Colloidal Suspensions of Lanthanide Oxides in Aqueous Solvents

The general procedure includes adding excess ammonium hydroxide to a solution of lanthanide chloride and polysaccharide (polymer), followed by heating, and performing six cycles of ultrafiltration against water using a 30 kDa MWCO membrane filter. After ultrafiltration, the colloid preparations formed were filtered through a 0.2 micron filter and were stored at 4° C.

Alternatively, a solution of lanthanide chloride can be added to a solution of polysaccharide (polymer) and ammonium hydroxide, followed by heating, and performing six cycles of ultrafiltration against water using a 30 kDa MWCO membrane filter. After ultrafiltration, the colloid preparations formed were filtered through a 0.2 micron filter and were stored at 4° C.

### Example 6

### Preparation of Dextran T10 Associated Samarium Oxide

Dextran T10 (17 g) was dissolved in 200 mL water, and a solution of 5.7 g samarium chloride hexahydrate in 60 mL water was added. The mixture was passed through a 0.45 micron filter, purged with nitrogen for 10 min, and 20 mL of 28% ammonium hydroxide was added with stirring during a 2 min period. A transparent and colorless colloidal suspension was obtained which remained stable for 1 week.

In another preparation, dextran T10 (17 g) was dissolved in 200 mL water, and a solution of 5.7 g samarium chloride hexahydrate in 60 mL water was added. The mixture was passed through a 0.45 micron filter, purged with nitrogen for 10 min, and 20 mL of 28% ammonium hydroxide was added with stirring during a 2 min period. The mixture was heated to 80° C. for 2.5 h. A yellow color was generated in the reaction during the heating step. The product was exhaustively dialyzed against a 12000 MWCO membrane and passed through a 0.2 micron filter and stored at 4° C. The colloidal suspension remained colored during the dialysis but transparent indicating that the colloid was stable and suspended. No colored material was observed on the membrane.

In a third preparation, dextran T10 (17 g) was dissolved in 260 mL water. The mixture was passed through a 0.45 micron filter, purged with nitrogen for 10 min, and 20 mL of 28% ammonium hydroxide was added with stirring during a 2 min period. The mixture was heated to 80° C. for 2.5 h. During the heating step the reaction turned yellow orange. The product was exhaustively dialyzed against a 12000 MWCO membrane and passed through a 0.2 micron filter, and was stored at 4° C. The solution retained the color during the dialysis, and the solution remained transparent, indicating that the colored product was stable and was in solution. No colored material was observed on the membrane.

### Example 7

### Preparation of Reduced Dextran T1 Associated Dysprosium oxide

Reduced dextran T1 (17 g) is dissolved in 200 mL water, and a solution of 5.7 g of dysprosium chloride hexahydrate in 60 mL water is added. The mixture is passed through a 0.45 μm filter, purged with nitrogen for 10 min, and 20 mL of 28% ammonium hydroxide is added with stirring during a 2 min period. The mixture is heated to 80° C. for 2.5 h. The product is subjected to six cycles of ultrafiltration against water using a 30 kDa MWCO membrane filter. After ultrafiltration, the product is filtered through a 0.2 micron filter and stored at 4° C.

### Example 8

### Preparation of Reduced Dextran T5 Associated Cerium Oxide

Reduced dextran T5 (17 g) is dissolved in 200 mL water, and a solution of 5.7 g of cerium chloride hexahydrate in 60 mL water is added. The mixture is passed through a 0.45 μm filter, purged with nitrogen for 10 min, and 20 mL of 28% ammonium hydroxide is added with stirring during a 2 min period. The mixture is heated to 80° C. for 2.5 h. The product is subjected to six cycles of ultrafiltration against water using a 30 kDa MWCO membrane filter. After ultrafiltration, the product is filtered through a 0.2 micron filter and stored at 4° C.

### Example 9

### Preparation of Reduced Dextran T10 Associated Gadolinium Oxide

Reduced dextran T10 (17 g) was dissolved in 200 mL water, and a solution of 5.7 g of gadolinium chloride hexahydrate in 60 mL water was added. The mixture was passed through a 0.45 micron filter, purged with nitrogen for 10 min, and 20 mL of 28% ammonium hydroxide was added with stirring during a 2 min period. The mixture was heated to 80° C. for 2.5 h. The product was subjected to six cycles of ultrafiltration against water using a 30 kDa MWCO membrane filter. After ultrafiltration, the product was filtered through a 0.2 micron filter and stored at 4° C. To determine stability in response to autoclaving, a sample of the product was placed in a sealed 5 mL glass vial, and heated to 121° C. for 30 min. No precipitation was seen and the particle size remained unchanged. Other colloidal lanthanide oxides were prepared in a similar manner by substitution of alternative lanthanides for gadolinium.

### Example 10

### Preparation of Reduced Dextran T10 Gadolinium oxide Associated without Heating

Reduced dextran T10 (17 g) was dissolved in 200 mL water, and a solution of 5.7 g of gadolinium chloride hexahydrate in 60 mL water was added. The mixture was passed through a 0.45 micron filter, purged with nitrogen for 10 min, and 20 mL of 28% ammonium hydroxide was added with stirring during a 2 min period. The mixture was stirred for 2.5 h. The product was subjected to six cycles of ultrafiltration against water using a 30 kDa MWCO membrane filter. After ultrafiltration, the product was filtered through a 0.2 micron filter and stored at 4° C.

### Example 11

### Preparation of Reduced Dextran T10 Associated Gadolinium Oxide by Reverse Addition without Heating

Reduced dextran T10 (17 g) was dissolved in 200 mL of 2.8% ammonium hydroxide. A second solution of 5.7 g of gadolinium chloride hexahydrate in 60 mL water was prepared. The two solutions were passed through a 0.45 micron filter separately. The gadolinium chloride solution was then added to the reduced dextran and ammonium hydroxide solution with stirring during a 5 min period. The mixture was stirred for 2.5 h. The product was subjected to six cycles of ultrafiltration against water using a 30 kDa MWCO membrane filter. After ultrafiltration, the product was filtered through a 0.2 micron filter and stored at 4° C.

### Example 12

### Preparation of Reduced Dextran T10 Associated Europium Oxide

Reduced dextran T10 (17 g) was dissolved in 200 mL water, and a solution of 5.7 g of europium chloride hexahydrate in 60 mL water was added. The mixture was passed through a 0.45 micron filter and 20 mL of 28% ammonium hydroxide was added with stirring during a 2 min period. The mixture was heated to 80° C. for 2.5 h. The product was subjected to six cycles of ultrafiltration against water using a 30 kDa MWCO membrane filter. After ultrafiltration, the product was filtered through a 0.2 micron filter and stored at 4° C.

### Example 13

### Preparation of Reduced Pullulan Associated Lanthanum Oxide

Reduced pullulan T1 (17 g) is dissolved in 200 mL water, and a solution of 5.7 g of lanthanum chloride hexahydrate in 60 mL water is added. The mixture is passed through a 0.45 micron filter, purged with nitrogen for 10 min, and 20 mL of 28% ammonium hydroxide is added with stirring during a 2 min period. The mixture is heated to 80° C. for 2.5 h. The product is subjected to six cycles of ultrafiltration against water using a 30 kDa MWCO membrane filter. After ultrafiltration, the product is filtered through a 0.2 micron filter and stored at 4° C.

### Example 14

### Preparation of Gadolinium Oxide Associated with Carboxymethyl Reduced Dextran T10

Reduced carboxymethyl dextran T10 (17 g) was dissolved in 200 mL water and a solution of 5.7 g of gadolinium chloride hexahydrate in 60 mL water was added. The resulting solution was filtered through a 0.45 micron pore size filter, and 20 mL of 28% ammonium hydroxide was added. The colloidal mixture was heated to 80° C. and maintained at that temperature for two hours. The solution was then autoclaved for 15 min and ultrafiltered 6 times with a 30 kDa MWCO membrane. A final concentration of 10 mg Gd/g was obtained.

To determine stability in response to autoclaving, a sample of the product was placed in a sealed 5 mL glass vial, and heated to 121° C. for 30 min. No precipitate was observed and the particle size remained unchanged. Other lanthanides were prepared in a similar manner by substitution of alternative lanthanides for gadolinium.

### Example 15

### Preparation of CrossLinked Dextran Covered Lanthanide Oxide (CLLO)

The dextran covered lanthanide colloid was prepared according to Example 6 except that lanthanum chloride was substituted for samarium chloride. In a fume hood, to 40 mL of colloid was added 100 mL of 5M NaOH, 40 mL distilled water and 40 mL epichlorohydrin. The mixture was incubated at room temperature for about 24 hours with shaking to promote interaction of the organic phase (epichlorohydrin) and aqueous phase which includes the dextran covered colloid. Epichlorohydrin was removed by placing the colloid in a dialysis bag and dialyzing against 20 changes of distilled water of 20 liters each. After dialysis, the product was filtered through a 0.2 micron filter and stored at 4° C. The size and aqueous stability of the colloid suspension were unaffected by this treatment.

### Example 16

### Preparation of CrossLinked Reduced Dextran Covered Lutetium Oxide

The reduced dextran covered colloid was prepared essentially according to Example 10 except that lutetium chloride was substituted for gadolinium chloride. In a fume hood, to 40 mL of colloid was added 100 mL of 5M NaOH, 40 mL of distilled water and 40 mL of epichlorohydrin. The mixture was incubated at room temperature for about 24 hours with shaking to promote interaction of the organic phase (epichlorohydrin) and aqueous phase which includes the dextran covered colloid. Epichlorohydrin was removed by placing the colloid in a dialysis bag and dialyzing against 5 changes of distilled water of 4 liters each. After dialysis, the product was filtered through a 0.2 micron filter and stored at 4° C. The size and aqueous stability of the colloid suspension were unaffected by this treatment.

### Example 17

### Preparation of Amino CrossLinked Dextran and Reduced Dextran Covered Lutetium Oxide

Crosslinked colloids were prepared according to Examples 15 and 16, except that prior to dialysis a 10-fold excess of ammonium hydroxide was added. The solution was stirred for 12 hours and then purified by 6 cycles of ultrafiltration against a 30 kDa MWCO membrane.

The size-properties and aqueous stability of the colloid suspension were observed to be unaffected by this treatment. The crosslinked amino-dextran is not dissociated by high temperature from the colloid.

### Example 18

### Preparation of Reduced Dextran T10 Associated Gadolinium Oxide and Europium Oxide

A gadolinium colloid prepared according to Example 9 and a europium colloid prepared according to Example 10 were mixed in equal amounts to form a stable colloidal suspension. The suspension was autoclaved for 30 minutes and the suspension was observed to remain stable.

In a similar manner, combined suspensions of crosslinked europium and gadolinium colloid were mixed in equal amounts to form a stable colloidal suspension. The suspension was autoclaved for 30 minutes and the suspension was found to have remained stable.

### Example 19

### Preparation of Colloidal Particles Containing Two Lanthanide Elements

Reduced dextran T10 (17 g) was dissolved in 200 mL water, and a solution of 5.45 g of gadolinium chloride hexahydrate and 0.25 g of europium chloride hexahydrate in 60 mL water was added. The mixture was passed through a 0.45 micron filter, purged with nitrogen for 10 min, and 20 mL of 28% ammonium hydroxide was added with stirring during a 2 min period. The mixture was stirred for 2.5 h. The product was subjected to six cycles of ultrafiltration against water using a 30 kDa MWCO membrane filter. After ultrafiltration, the product was filtered through a 0.2 micron filter and was stored at 4° C.

### Example 20

### Preparation of Colloidal Particles Containing Three Lanthanide Elements

Reduced dextran T10 (17 g) was dissolved in 200 mL water, and a solution of 5.25 g of gadolinium chloride hexahydrate, 0.25 g of europium chloride hexahydrate, and 0.25 g of lanthanum chloride heptahydrate in 60 mL water was added. The mixture was passed through a 0.45 micron filter, purged with nitrogen for 10 min, and 20 mL of 28% ammonium hydroxide was added with stirring during a 2 min period. The mixture was stirred for 2.5 h. The product was subjected to six cycles of ultrafiltration against water using a 30 kDa MWCO membrane filter. After ultrafiltration, the product was filtered through a 0.2 micron filter and stored at 4° C.

### Example 21

### Preparation of Lutetium Oxide Colloid Modified with Fluorescein

A 1 mL sample of amino crosslinked lutetium colloid prepared as described in Example 17 and at a concentration of 10 mg Lu/mL was mixed with 1 mL of 0.2 M sodium carbonate pH 8.8 and 1 mg of fluorescein isothiocyanate. The solution was reacted at room temperature for 2 h and exhaustively dialyzed against phosphate buffered saline. Dot blots of the final product were observed to be bright yellow (fluorescent) when illuminated with 254 nm UV light. Dot blots of similarly treated control crosslinked lutetium colloid (no amino groups) showed no fluorescence. The size, and aqueous stability of the colloid suspension were unaffected by this treatment. The crosslinked amino-fluorescein dextran was not dissociated from the colloid by autoclaving.

### Example 22

### Preparation of Gadolinium Oxide Colloid Modified with Biotin

A 1 mL sample of amino crosslinked gadolinium colloid was prepared essentially as described in Example 17 (except that gadolinium chloride was substituted for lutetium chloride), at a concentration of 10 mg Gd/mL was mixed with 1 mL of 0.2 M sodium carbonate pH 8.8 and 1 mg of N-hydroxysuccinimide biotin. The solution was reacted at room temperature for 2 hours and exhaustively dialyzed against phosphate buffered saline. The resulting colloid was mixed with avidin, and aggregation was observed, confirming the covalent attachment of biotin as a result of the reaction. Similarly, treatment of “biotin” modified crosslinked lutetium colloid did not aggregate, confirming the role of amines in binding biotin to the colloid. The size and aqueous stability of the colloid suspension were unaffected by biotin modification.

### Example 23

### Concentration of Non-Colloidal Lanthanides in Colloidal Preparations

Stable colloidal suspensions of lanthanide and lutetium oxides (prepared according to Examples 13 and 17) at a concentration of 10 mg/mL were subjected to ultrafiltration against a 1000 MWCO membrane. The amount of colloid present in the ultrafiltrate was measured by neutron activation analysis, and was found to be less than 1% of the amount of total lanthanide present in each preparation.

Sterilization: Stable colloids prepared as described in examples 13 and 17 were sterilized by each of three processes: sterile filtration, gamma irradiation, and autoclaving, as described below.

### Example 24

### Sterile Filtration

Lanthanide oxides at a concentration of 10 mg/mL were passed through a 0.1 micron filter. The concentration of the lanthanide prior and following filtration were compared by neutron activation analysis. All concentrations were unchanged following filtration.

### Example 25

### Preservation of Filter Sterilized Lanthanide Oxide Colloid by Lyophilization

Lyophilization of filter sterilized paramagnetic lanthanide oxide colloids utilizes a freezing step, a primary drying step and a secondary drying step.

For the freezing step, 10 mL of colloid made according to Example 13 is placed in a glass bottle. The colloid contains Eu 10 mg/mL, with 30 mg/mL dextran T-10 added as excipient. The colloid is then placed in a freeze-drying apparatus, with the shelf temperature set for between −40° C. and −50° C. After 8 hours, the colloid reaches the shelf temperature, i.e. is frozen.

For the primary drying step, the vacuum is turned to a maximal setting, and the shelf temperature allowed to rise to 0° C. for 48 hours. The vacuum falls during primary drying, with a final value of less than about 100 microns being attained. For the secondary drying step, the vacuum is maintained and the shelf temperature increased to +20° C. for 24 hours.

As a result of lyophilization, a porous, hydophilic matrix is formed, with a volume equal to that of the original colloid, 10 mL. The matrix dissolves readily upon addition of water, saline, dextrose or other physiological fluid.

Upon reconstitution with distilled water, the stability, concentration, size, and magnetic properties of the starting colloid are found to be unaffected by this lyophilization procedure.

### Example 26

### Sterilization by Autoclaving

Colloidal lanthanide oxides prepared according to Examples 9, 14, and 15 at a concentration of 10 mg/mL were subjected to autoclaving (at a temperature of 121° C.) for 15 minutes. The resulting autoclaved colloids were observed for size and stability of the amine colloid, both of which were found to be unaffected by this treatment.

### Example 27

### Sterilization by Prolonged Autoclaving

Colloidal lanthanide oxides prepared according to Examples 9, 14, and 15 at a concentration of 10 mg/mL were subjected to autoclaving (at a temperature of 121° C.) for 240 minutes. The resulting autoclaved colloids were observed for size and stability of the amine colloid, both of which were observed to be unaffected by this treatment.

### Example 28

### Sterilization by Gamma Irradiation

Lanthanide oxides prepared according to Examples 9, 14, and 15 at a concentration of 10 mg/mL were exposed to a high gamma irradiation field to achieve sterility. The resulting autoclaved colloids were observed for size and stability of the amine colloid, both of which were found to be unaffected by this treatment.

### Example 29

### Stability of Gadolinium Oxide in a Magnetic Field

Colloidal gadolinium oxide prepared according to Examples 14 was positioned on a 5000 Os magnet for a prolonged time period of 14 days. No collection of solid material was observed at the magnet interface. A sample was obtained from the upper portion of the container after treatment as well as from the container prior to treatment. These two samples were observed to have identical concentrations of gadolinium as shown by neutron activation analysis. The concentration, size, and stability of the colloid were observed to be unchanged compared to the starting colloid.

### Example 30

### Stability of Europium Oxide in a Gravitational Field

Colloidal europium oxide prepared according to Example 12 was incubated for 6 months at room temperature. No sediment was observed to have formed. A sample was obtained from the upper portion of the container after treatment as well as from the container prior to treatment. These two samples were observed to have identical concentrations of europium as shown by neutron activation analysis. The concentration, size, size, and stability of the starting colloid were observed to be unaffected by this treatment.

### Example 31

### Stability of Gadolinium Oxide in a Human Serum

Colloidal gadolinium oxide prepared according to Examples 9 and 14 was added to human serum and incubated for 24 hours at room temperature. No aggregation, flocculation or collection of solid material at the bottom of the container was observed.

### Example 32

### Effect of Compositions on Cell Viability

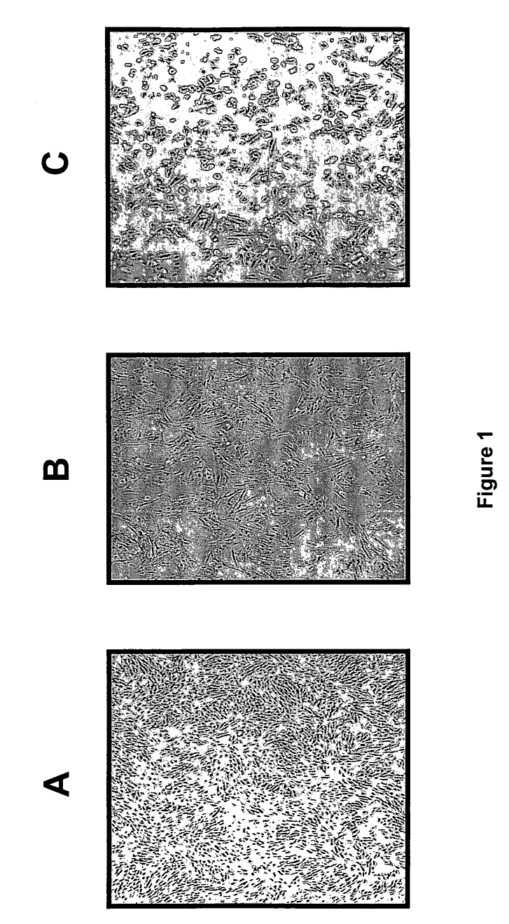

In order to assess potential toxicity of stable colloidal suspensions of lanthanide oxides, pig mesenchymal stem cells (MSC) were grown in the presence of high concentrations of colloidal europium oxide (prepared according to Example 12) for various lengths of time. In all experiments colloid was incubated with cells in growth medium for 12 hours (at a concentration of 1 mg Eu/mL) which was then washed away. As a positive control to demonstrate toxic cell death, pig MSC were also incubated in thimerisol. Results observed for a typical set of experiments are shown in FIG. 1 Panels A and B. The data show MSC cells 6 days following treatment with no reagent (Panel A), or treated with europium oxide (Panel B).

Cells were observed to be healthy and growing after six days in culture whereas in FIG. 1 Panel C, cells treated with thimerasol died in less than 24 hours. The conclusion is that lanthanide materials were non-toxic to cells. Similar experiments were performed on other cell types including myocytes and fibroblasts, and the same observations were made.

### Example 33

### Cell Labeling with Lanthanide Oxide

Compositions herein comprising at least one type of nanoparticles that are lanthanide oxide-based are useful to label cells in order to quantitatively track them in vivo. One example is the use of Europium oxide nanoparticles to label stem cells in vitro for therapeutic applications in heart disease.

Labeled stem cells are prepared using the following protocol. Primary porcine mesenchymal stem cells were isolated from bone marrow aspirates using 100 μm mesh filters, mononuclear cell gradient separation (buffy-coat) and plastic adherence methods (as is well known to those skilled in the art of cell isolation and growth). Cells were cultured using standard conditions with Dulbecco's medium with 10% serum. Cells were first plated in large 100 mm dishes with frequent medium changes for a period of one week. Remaining adherent cells were released from the plate surface by trypsinization, and were then centrifuged, were resuspended in growth medium and were plated in both multi-well plates and single dishes after cell counting using a hemacytometer. Cells were plated in numbers from 10,000 to 1 million cells per dish or well.

Colloidal europium oxide prepared according to Example 12 was diluted from stock at 1:10 to 1:50 into the growth medium, and the cells were incubated for 12 hours in the presence of the europium oxide nanoparticles. At the end of the incubation cells were trypsinized, centrifuged, washed two times, placed into vials and dried. Samples for all points were performed in, at least, triplicate. Europium uptake was assayed via neutron activation analysis, and the results were reported in disintegrations per minute (DPMs) per cell.

Control plates containing growth medium with europium oxide nanoparticles in the absence of cells showed less than 0.1% of isotope uptake (non-specific background) relative to cell-containing plates.

Data showed, at the lowest dilution after 1 hour of incubation, that there were 3.7 DPMs per cell; at 12 hours there were 3.9 DPMs per cell. This level of uptake yields a minimum sensitivity of detection of 10 cells per sample.

### Example 34

### Toxicity Studies in Rats: Analysis of Potential Toxicity of Reduced Dextran, Non-reduced Dextran, and CMRD Associated Colloids Administered in Vast Excess to Rats

A procedure to measure the extent of rat paw edema response is employed to determine if the presence of reduced dextrans or their derivatives, rather than non-reduced native dextrans, in the coating of the lanthanide oxide colloids could decrease or eliminate potential human adverse reactions upon intravenous injection.

Rat paw edema is measured as the volume of the paw prior to and subsequent to injection of test material, using a plethysmometer, which is a differential volume measuring device. The dose of test material is injected, and a second reading is taken after a designated interval, and the percent change in paw volume is calculated. The dose administered in these studies is 100 mg Gd/kg body weight, a dose much greater than that used as an imaging agent in rats, pigs, and humans.

TABLE 2
Effect of native and reduced polysaccharide
associated particles on rat edema.

| coating and particle | % edema |
|---|---|
| native dextran coated gadolinium oxide | >50 |
| reduced dextran coated gadolinium oxide | 13 |
| carboxymethyl reduced dextran coated gadolinium oxide | 0 |

The results observed following administration of lanthanide oxides coated with each of reduced and non-reduced T10 dextrans are shown in Table 2. A marked decrease in edematous anaphylactic response is observed in rats which are administered a lanthanide oxide preparation having the reduced dextran or reduced dextran derivatives associated with the lanthanide oxide, compared to rats administered a preparation having a native non-reduced dextran associated with the lanthanide oxide.

### Example 35

### Pharmacokinetics in Rat and Blood Clearance of CMRD Associated Gadolinium Oxide

Three male CD rats (Charles River Laboratoraties, Wilmington, Mass.; weight range 272 to 290 g) are anaesthetized intraperitoneally with a long lasting anesthetic, Inactin (100 mg per kg body weight). The femoral artery and vein are exposed by a small incision at the hip-femur joint, and the artery is cannulated with PE50 tubing connected to a 1 mL syringe filled with heparinized saline (10 units per ml). To serve as a baseline, 0.25 mL of arterial blood was collected at time zero, and CMRD associated lanthanide oxide colloid (Example 9) is injected into the femoral artery. Blood samples of 0.25 mL are collected at suitable times.

T1 magnetic relaxation times are measured in each sample, and the relaxivity (1/T1) is calculated. First-order reaction kinetics are used to determine the half-life of the sample in the blood (t_{1/2}). The equation used to fit the data is:
1/T1−1/T_{baseline}=Ae^{-kt}
where 1/T1 is the relaxivity of the blood at time t post-injection; 1/T_{baseline} is the baseline relaxivity, and Ae^{-kt} represents the first-order decay of the test material from the blood. Taking the natural log of each side of this equation yields:
   ln(1/T1−1/T_{baseline})=−kt+lnA₀

According to this second equation, a graph of In (1/T1−1/T_{baseline}) versus time, t, should give a straight line with slope −k (the first order rate constant) and intercept lnA₀ (which equals ln (1/T1−1/T_{baseline at time zero}) if the rate of removal of the lanthanide oxide from blood follows first order kinetics. A straight line is obtained. The half-life (t_{1/2}), which is the time that the amount of CMRD associated lanthanide oxide decreases to one half its amount of concentration in the blood, is determined to be greater than 50 min.

### Example 36

### Magnetic Resonance Imaging Using Colloidal Gadolinium Oxide

Colloidal gadolinium Oxide prepared according to Example 9, and Gadolinium DTPA, each at a concentration of each of 1.0 and 0.1 nM Gd, were added to a volume of 1 mL in a 2 mL screw cap plastic tube, and were subjected to MRI using a T1 pulse sequence.

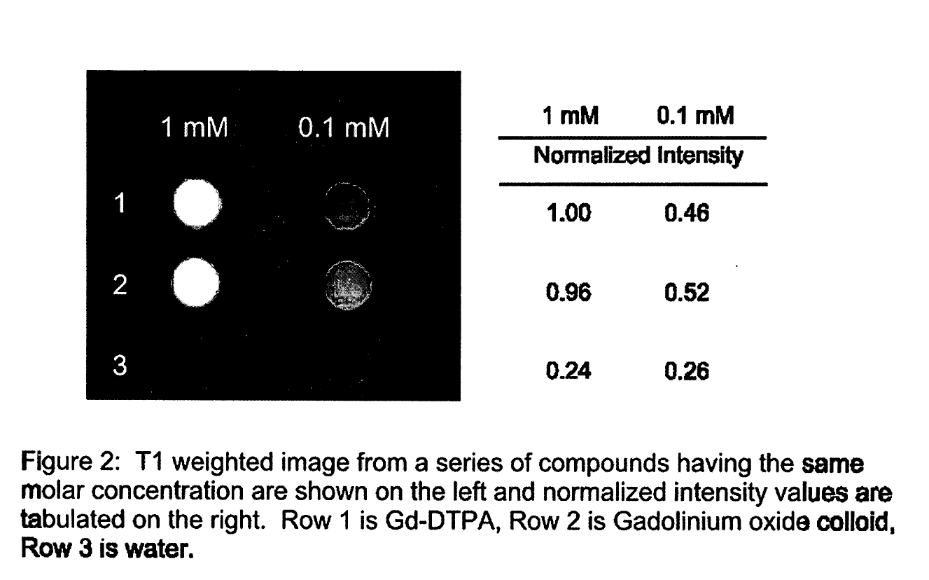

The colloidal gadolinium oxide and gadolinium DTPA were found to be equally potent as contrast agents. FIG. 2 shows data from a set of photographs of a T1 weighted image, from a series of compounds having the same molar concentrations, as shown in the figure on the left, and with normalized intensity values, as tabulated on the right. The compound in row 1 is Gd-DTPA, and is comparable in intensity to the compound in row 2, gadolinium oxide colloid, prepared according to Example 9. Row 3 is water, a negative control.

### Example 37

### Neutron Capture Therapy Using a Stable Aqueous Colloid of Gadolinium Oxide

Boron neutron capture therapy (BNCT) for the treatment of malignancy has been extensively investigated. However, boron targeting techniques are still premature and the investigation of more efficacious boron carriers is being addressed. Gadolinium neutron capture therapy (GNCT) may prove to be a more useful approach. Gadolinium-157 is an appropriate atom for this therapy, since it has a large thermal neutron cross section of 255,000 barns which is 65 times greater than boron-10, and releases Auger electrons, internal conversion electrons, gamma rays, and x-rays by a single thermal neutron capture reaction sharing among them the total kinetic energy of 7.7 MeV, which is more than 2 time greater then ¹⁰B(n,α)⁷Li reaction. In the boron-based NCT, high LET (linear energy transfer) particles of a and its recoil ⁷Li particle release 3.3 MeV only within their trajectory of less than 14 μm. The larger therapeutic area offered by gadolinium-based reagent is advantageous in many clinical settings. Moreover, the inherent ability for MRI imaging of drug location is an added advantage.

The GNCT therapeutic reagent herein comprises a stable gadolinium oxide colloid that is associated with a tumor-directing agent, such as folate or an antibody. The reagent in administered to the subject. After a predetermined time period, such as 24 hours, MRI is used to evaluate the subject's tumor site to confirm reagent uptake within the tumor bed and to confirm clearance of the reagent in normal tissue and blood. The subject is then exposed to a collimated field of epithermal neutrons directed at the tumor bed. The therapeutic event occurs instantaneously following absorption of a neutron by gadolinium. After a predetermined time period, such as 24 hours, MRI is used to evaluate the effectiveness of the treatment.

What is claimed is:

1. A stable aqueous colloid composition comprising at least one lanthanide oxide.

2. The composition according to claim 1 comprising at least two lanthanide oxides wherein the lanthanide oxides are formed separately and subsequently mixed.

3. The composition according to claim 1 comprising a set of colloidal particles, each particle containing two or more lanthanide elements as oxides.

4. The composition according to claim 1, wherein at least one lanthanide oxide is an oxide selected from a group of oxides of lanthanide elements consisting of lanthanum, cerium, praseodymium, neodymium, promethium, samarium, europium, gadolinium, terbium, dysprosium, holmium, erbium, thulium, ytterbium, and lutetium.

5. The composition according to claim 1, wherein the colloid has a size of between about 1 nm and about 500 nm.

6. The composition according to claim 5, wherein a distribution of colloid particle sizes has a standard deviation value which is less than about 150% of the mean value of the distribution.

7. The composition according to claim 1, wherein the lanthanide oxide is associated with a polymer.

8. The composition according to claim 7, wherein the lanthanide oxide is gadolinium oxide.

9. The composition according to claim 7, wherein the polymer is selected from the group consisting of polyol, polyether, polyphosphoester, polyamide, and polystyrene.

10. The composition according to claim 9, wherein the polyol is a polysaccharide.

11. The composition according to claim 10, wherein the polysaccharide is a dextran, a reduced dextran, an oxidized dextran, or a derivatized dextran.

12. The composition according to claim 11, wherein the derivatized dextran is carboxy methyl reduced dextran.

13. The composition according to claim 7, wherein the polymer is crosslinked.

14. The composition according to claim 13, wherein the polymer is crosslinked with an agent selected from the group consisting of epichlorohydrin, glutaraldehyde, di-N-hydroxysuccinimide suberate, diethylenetriaminepentaacetic acid anhydride, cyanogen bromide, ethylchloroformate, and divinyl sulfone.

15. The composition according to claim 7, wherein the polymer is an amine containing polymer.

16. The composition according to claim 7, wherein the polymer facilitates opsonization.

17. The composition according to claim 7, wherein the polymer blocks opsonization.

18. The composition according to claim 7, wherein the polymer facilitates receptor binding.

19. The composition according to claim 7, wherein the colloid has a plasma half-life in a subject that is greater than about 1 minute.

20. The composition according to claim 19, wherein the colloid has a plasma half-life in a subject that is greater than about 10 minutes.

21. The composition according to claim 7, wherein the colloid provides minimal incidence of anaphylaxis in a subject.

22. The composition according to claim 7, wherein the colloid can be administered to a subject at a rate substantially greater than about 1 mL/min.

23. The composition according to claim 7, wherein the colloid can be administered to a subject at a rate substantially greater than about 10 mL/min.

24. The composition according to claim 7, wherein the lanthanide oxide possesses magnetic properties.

25. The composition according to claim 7, which is stable at a temperature of at least about 100° C.

26. The composition according to claim 7, which is stable at a temperature of at least about 121° C.

27. The composition according to claim 7, which is stable at a temperature of at least about 121° C. for a period of time effective to sterilize the complex wherein the sterilization time is between about 5 and about 600 minutes.

28. The composition according to claim 7, which is sterile.

29. The composition according to claim 28, which is sterilized by autoclaving.

30. The composition according to claim 7, wherein the colloid comprises a core consisting substantially of at least one crystal of lanthanide oxide.

31. The composition according to claim 28, wherein the colloid is suspended in a buffer having physiological pH and osmolarity.

32. A method of synthesis of a stable aqueous colloid comprising at least one lanthanide oxide, the method comprising: providing an aqueous acidic solution including at least one lanthanide salt and at least one polymer; and neutralizing the solution by controlled addition of a base.

33. The method according to claim 32, further comprising prior to neutralizing the solution, providing an aqueous acidic solution including at least two lanthanide salts and at least one polymer and neutralizing the solution by controlled addition of a base.

34. The method according to claim 32, wherein the lanthanide salt is a halide or an acetate.

35. The method according to claim 32, further comprising heating the neutralized solution to a temperature of between about 25° C. and about 121° C. for between 0.1 minutes and 24 hours.

36. A method according to claim 32, wherein at least two stable aqueous colloidal lanthanide oxides are prepared separately and subsequently combined.

37. The method according to claim 32, wherein the polymer is a polysaccharide.

38. The method according to claim 37, wherein the polysaccharide is an arabinogalactan, a dextran, a reduced dextran, an oxidized dextran, or a derivatized dextran.

39. The method according to claim 38, wherein the derivatized dextran is carboxy methyl reduced dextran.

40. The method according to claim 32, wherein the ratio of the weight of polymer to the weight of lanthanide salts is between about 0.1:1 and about 50:1.

41. The method according to claim 32, further comprising crosslinking the polymer.

42. The method according to claim 41, wherein crosslinking the polymer further comprises using a crosslinking agent selected from the group consisting of epichlorohydrin, glutaraldehyde, disuccinimydyl suberate, diethylenetriaminepentaacetic acid anhydride, cyanogen bromide, ethylchloroformate, and divinyl sulfone.

43. The method according to claim 41, further comprising modifying the crosslinked polymer with a reagent selected from the group of an amine, a carboxyl, a sulfhydryl, a sulfate, and a diene group.

44. The method according to claim 35, further comprising maintaining the temperature of the aqueous acidic solution prior to heating between about 0° C. and about 95° C.

45. The method according to claim 32, wherein the base is sodium hydroxide, sodium carbonate, or ammonium hydroxide.

46. The method according to claim 32 further comprising sterilizing the stable colloid.

47. The method according to claim 46, wherein sterilizing comprises autoclaving.

48. The method according to claim 46, wherein sterilizing comprises gamma irradiation.

49. The method according to claim 46, wherein sterilizing comprises filtration.

50. The method according to claim 49, further comprising lyophilizing the resulting filter-sterilized colloid.

51. The method according to claim 50, wherein the filter-sterilized colloid is lyophilized in the presence of a compatible excipient.

52. The method according to claim 51, wherein the excipient comprises a dextran or a citrate anion.

53. The method according to claim 51, further comprising resuspending the lyophilized colloid in an aqueous composition.

54. A use of a composition comprising at least one sterile stable aqueous lanthanide oxide colloid for research, diagnosis, or therapy.

55. The use according claim 54, wherein prior to use the composition is sterilized by autoclaving.

56. The use according to claim 54, further comprising providing the sterile composition in a unit dosage of between about 0.1 mL and about 500 mL.

57. The use according to claim 54, further comprising providing the stable aqueous colloid as a contrast agent for magnetic resonance technology.

58. The use according to claim 57, wherein the contrast agent is provided at a physiological pH and osmolarity, and is terminally sterilized by autoclaving.

59. The use according to claim 54 for imaging an organ, tissue or at least one cell of a subject by in vivo magnetic resonance (MR), further comprising: administering to the subject an effective amount of the stable sterile aqueous colloid dispersed in a physiologically acceptable carrier; and obtaining an MR image.

60. The use according to claim 54, wherein the lanthanide oxide is gadolinium oxide.

61. The use according to claim 54, wherein the stable aqueous colloid comprising at least one lanthanide oxide is a T1 magnetic resonance contrast agent.

62. The use according to claim 54, wherein the stable aqueous colloid comprising at least one lanthanide oxide is a T2 magnetic resonance contrast agent.

63. The use according to claim 54 further comprising providing a stable aqueous colloid as a contrast agent for computer assisted tomography.

64. The use according to claim 63 wherein the contrast agent is provided at a physiological pH and osmolarity, and is terminally sterilized by autoclaving.

65. The use according to claim 54 for imaging an organ, tissue or at least one cell of a subject by in vivo computer assisted tomography (CT), further comprising:
administering to the subject an effective amount of the stable sterile aqueous colloid dispersed in a physiologically acceptable carrier; and obtaining the CT image.

66. The use according to claim 54, further comprising providing a stable aqueous colloid as an agent for neutron capture therapy.

67. The use according to claim 66 wherein the neutron capture therapy agent is provided at a physiological pH and osmolarity, and is terminally sterilized by autoclaving.

68. The use according to claim 66 for treating a subject, organ, tissue or at least one cell, further comprising administering to the subject, organ, tissue or cell an effective amount of the sterile stable aqueous colloid dispersed in a physiological acceptable carrier, and exposing the subject, organ, tissue or cell to neutrons, wherein the neutrons activate the lanthanide resulting in production of charged particles for treating the subject, organ, tissue or cell.

69. The use according to claim 68 wherein the organ, tissue or at least one cell is administered the colloid ex vivo.

70. The use according to claim 68 wherein the organ, tissue or at least one cell is administered the colloid in vivo.

71. The use according to claim 68, wherein the charged particles are alpha particles or electrons.

72. The use according to claim 54 further comprising providing a stable aqueous colloid as a brachytherapy agent.

73. The use according to claim 72, wherein the brachytherapy agent is provided at a physiological pH and osmolarity, and is terminally sterilized by autoclaving.

74. The use according to claim 72, further comprising exposing the colloid to neutrons to obtain a radioactive colloid.

75. The use according to claim 74, wherein the exposure of the colloid to neutrons occurs ex vivo.

76. The use according to claim 74, wherein the exposure of the colloid to neutrons occurs in vivo.

77. The use according to claim 72, further comprising administering an effective amount of the radioactive colloid to the subject.

78. The use according to claim 54, further comprising providing the stable aqueous colloid as a cell or virus labeling agent for tracking cells or viruses.

79. The use according to claim 78, further comprising contacting the cells with the stable aqueous colloid.

80. The use according to claim 78, wherein the cells are in a subject.

81. The use according to claim 78, wherein the stable aqueous colloid further comprises a coating that targets a specific set of cells.

82. The use according to claim 78 wherein the cell tracking agent is provided at a physiological pH and osmolarity and is terminally sterilized by autoclaving.

83. The use according to claim 78, wherein tracking cells is used to assess the success of cellular therapy.

84. The use according to claim 79, wherein contacting the cells is performed ex vivo.

85. The use according to claim 78 wherein the cells selected for labeling are eukaryotic cells.

86. The use according to claim 85 wherein the eukaryotic cells are human therapeutic stem cells.

87. The method according to claim 78 wherein tracking further comprises imaging the cells by magnetic resonance technology or neutron activation analysis.
